(19) United States
(12) Patent Application Publication
(10) Pub. No.: US 2025/0280372 A1
(43) Pub. Date: Sep. 4, 2025

(54) POWER SCALING AND VIRTUALIZATION FOR MULTI-RESOURCE TRANSMISSION

(71) Applicant: Telefonaktiebolaget LM Ericsson (publ), Stockholm (SE)

(72) Inventors: Robert Mark HARRISON, Grapevine, TX (US); Sven JACOBSSON, Västra Frölunda (SE); Andreas NILSSON, Göteborg (SE); Chandan PRADHAN, Yokohama (JP)

(21) Appl. No.: 18/858,905

(22) PCT Filed: Apr. 28, 2023
(86) PCT No.: PCT/IB2023/054478

§ 371 Date: Oct. 22, 2024

Related U.S. Application Data
(60) Provisional application No. 63/336,611, filed on Apr. 29, 2022.

(51) Int. Cl. H04W 52/42; H04L 5/00; H04W 52/36

(52) U.S. Cl. CPC H04W 52/42; H04L 5/0051; H04W 52/367

(57) ABSTRACT

A method, system and apparatus are disclosed. According to embodiments, a wireless device is configured to receive a first indication of a first precoder for use with a first antenna port signal set that carries a first portion of a physical channel and is associated with a first SRS resource of the plurality of SRS resources, receive a second indication of a second precoder for use with a second antenna port signal set that carries a second portion of the physical channel and is associated with a second SRS resource of the plurality of SRS resources, adjust the first and second physical channel portion according to the first and second indications, forming a first and second signal power, each antenna port signal in the first antenna port signal set is adjusted by a number of antenna ports of the first antenna port signal set with NZP.

### FIELD

The present disclosure relates to wireless communications, and in particular, to multi-resource transmission with, for example, transmission power scaling and virtualization.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices, as well as communication between network nodes and between wireless devices.

In the time domain, NR downlink (DL) and uplink (UL) transmissions are organized into equally sized subframes of 1 ms each. A subframe is further divided into multiple slots of equal duration. The slot length depends on subcarrier spacing. For 15 kHz subcarrier spacing, there is only one slot per subframe. In general, for 15·2^{μ} kHz subcarrier spacing, where μ∈{0,1,2,3,4}, there are 2^{μ} slots per subframe. Finally, each slot consists of 14 symbols (unless extended cyclic prefix is configured).

In the frequency domain, a system bandwidth is divided into RBs each corresponding to 12 contiguous subcarriers. One subcarrier during one symbol interval forms one RE.

### UL Transmission/Precoding Schemes

The channel that carries data in the NR UL is called physical uplink shared channel (PUSCH). In NR, there are two possible waveforms that can be used for PUSCH: CP-OFDM and DFT-S-OFDM. Also, there are two transmission schemes specified for PUSCH: codebook (CB)-based precoding and NCB-based precoding.

The network node (e.g., gNB) configures, in RRC, the transmission scheme through the higher-layer parameter txConfig in the PUSCH-Config IE. CB-based transmission can be used for non-calibrated wireless device and/or for FDD (i.e., UL/DL reciprocity does not need to hold). NCB-based transmission, on the other hand, relies on UL/DL reciprocity and is, hence, intended for TDD.

### CB-Based Precoding

Codebook based (‘CB-based’) uplink Multiple Input-Multiple Output (MIMO) operation in NR can be described for the case where CP-OFDM is used for transmission with the following:

Transport blocks are provided by higher layers, error correction encoded to coded bits, and mapped to codewords, typically such that a codeword contains coded bits of a distinct transport block. In FIG. 1, CW is a MIMO codeword. It may be noted that 3GPP Rel-17 NR supports only one MIMO codeword on the uplink, but two codewords on the downlink. The codeword is modulated and mapped to a distinct set of r layers where the layers contain only the coded bits from the respective codeword. Each layer is multiplexed with a unique reference signal to that layer (a demodulation reference signal (DMRS)) in NR) that identifies the layer and can be used to estimate the channel through which the layer travels. The multiplexing can be where the DMRS is mapped to predetermined reference elements (REs) that do not contain higher layer data, where the DMRS is summed with the data bearing modulation symbols, etc. The layers are then precoded with a precoding matrix Wₖ which adjusts the gain and/or phase of each layer differently for each transmit antenna. The precoded layers are then summed together for each antenna. The signal for each antenna is then multiplexed with a reference signal specific to that antenna (an SRS in NR) that can be used to perform channel estimation of the signals carried on the antenna.

Precoding may be additionally described as representing the modulation symbols that are to be transmitted simultaneously in a same time/frequency resource element (TFRE), such as a resource element (RE) in NR, as an information carrying symbol vector s. The vector is formed with one modulation symbol per layer and then multiplied by the N×r precoder matrix W, which serves to distribute the transmit energy in a subspace of the N (corresponding to N antenna ports) dimensional vector space. The result after the multiplication may be referred to as a set of precoded layers. Each precoded layer is then mapped to the wireless device's transmit antennas, each of which may be identified with an antenna port.

The precoding matrix (or ‘precoder’) is typically selected from a codebook of possible precoder matrices and is typically indicated by means of a transmit precoder matrix indicator (TPMI), which specifies a unique precoder matrix in the codebook for a given number of symbol streams. The r symbols in s each correspond to a layer and r is referred to as the transmission rank or the number of layers. In this way, spatial multiplexing is achieved since multiple symbols can be transmitted simultaneously over the same TFREs. The number of layers r is typically adapted to suit the current channel properties.

The received N_{R}×1 vector yₙ for a certain TFRE on subcarrier n (or alternatively data TFRE number n) is thus modeled by

$${y}_{n} = {H}_{n} {Ws}_{n} + {e}_{n} \qquad Equation 1$$

Where eₙ is a noise/interference vector obtained as realizations of a random process. The precoder W can be a wideband precoder, which is constant over frequency, or multiple precoders W, each used for a portion of the subcarriers in a transmission, in which case the transmission can be said to be frequency selective.

The precoder matrix W is often chosen to match the characteristics of the MIMO channel matrix Hₙ, resulting in so-called channel dependent precoding. This is also commonly referred to as closed-loop precoding and essentially strives for focusing the transmit energy into a subspace which is strong in the sense of conveying much of the transmitted energy to from wireless device to receivers in the network. In addition, the precoder matrix may also be selected to strive for orthogonalizing the channel, meaning that after proper linear equalization at the wireless device, the inter-layer interference is reduced. One example method for a wireless device to select a precoder matrix W can be to select the Wₖ that maximizes the Frobenius norm of the hypothesized equivalent channel:

$${max}_{k} {‖ {\hat{H}}_{n} {W}_{k} ‖}_{F}^{2} \qquad Equation 2$$

Where
   Ĥₙ is a channel estimate, possibly derived from SRS.
   Wₖ is a hypothesized precoder matrix with index k.
   ĤₙWₖ is the hypothesized equivalent channel

In closed-loop precoding for the NR uplink, a network node such as a gNodeB (‘gNB’) transmits, based on channel measurements in the reverse link (uplink), TPMI to the wireless device that the wireless device should use on its uplink antennas. The network node (e.g., gNodeB or gNB) configures the wireless device to transmit sounding reference signal (SRS) according to the number of wireless device antennas it would like the wireless device to use for uplink transmission to enable the channel measurements. A single precoder that is may cover a large bandwidth (wideband precoding) may be signaled.

Other information than TPMI is generally used to determine the UL MIMO transmission state, such as SRS resource indicators (SRIs) as well as transmission rank indicator (TRIs). It may be noted that 3GPP Rel-17 NR jointly encodes TPMI and SRI in a precoding and number of layers field in control signaling. These parameters, as well as the modulation and coding state (MCS), and the uplink resources where PUSCH is to be transmitted, are also determined by channel measurements derived from SRS transmissions from the wireless device. The transmission rank, and thus the number of spatially multiplexed layers, is reflected in the number of columns of the precoder W. For efficient performance, it is important that a transmission rank that matches the channel properties is selected.

CB-based PUSCH is enabled if the higher-layer parameter txConfig is set to ‘codebook’. For dynamically scheduled PUSCH with configured grant type 2, CB-based PUSCH transmission can be summarized in the following steps:
1. The wireless device transmits SRS, configured in an SRS resource set with higher-layer parameter usage in SRS-Config IE set to ‘codebook’. Up to two SRS resources (for testing up to two virtualizations/beams/panels) each with up to four ports, can be configured in the SRS resource set.
2. The network node determines the number of layers (or rank) and a preferred precoder (i.e., TPMI) from a codebook subset based on the received SRS from one of the SRS resources. The codebook subset is configured via the higher-layer parameter codebookSubset, based on reported wireless device capability, and is one of
   fully coherent (‘fullyAndPartialAndNonCoherent’), or
   partially coherent (‘partialAndNonCoherent’), or
   non-coherent (‘nonCoherent’),
3. If two SRS resources are configured in the SRS resource set, the network node indicates the selected SRS resource via a 1-bit SRI field in the DCI scheduling the PUSCH transmission. If only one SRS resource is configured in the SRS resource set, the SRI field is not indicated in DCI.
4. The network node indicates, via DCI, the number of layers and the TPMI. DM-RS port(s) associated with the layer(s) are also indicated in DCI. The number of bits in DCI used for indicating the number of layers (if transform precoding is enabled, the number of PUSCH layers is limited to 1) and the TPMI is determined as follows (unless UL full-power transmission is configured, for which the number of bits may vary):
   4, 5, or 6 bits if the number of antenna ports is 4, if transform precoding is disabled, and if the higher-layer parameter maxRank in PUSCH-Config IE is set to 2, 3, or 4 (see Table 1).
   2, 4, or 5 bits if the number of antenna ports is 4, if transform precoding is disabled or enabled, and if the higher-layer parameter maxRank in PUSCH-Config IE is set to 1 (see Table 2).
   2 or 4 bits if the number of antenna ports is 2, if transform precoding is disabled, and if the higher-layer parameter maxRank in PUSCH-Config IE is set to 2 (see Table 3).
   1 or 3 bits if the number of antenna ports is 2, if transform precoding is disabled or enabled, and if the higher-layer parameter maxRank in PUSCH-Config IE is set to 1 (see Table 4).
   0 bits if 1 antenna port is used for PUSCH transmission.
      The wireless device performs PUSCH transmission over the antenna ports corresponding to the SRS ports in the indicated SRS resource.

TABLE 1
Precoding information and number of layers, for 4 antenna ports, if transform precoding
is disabled and maxRank = 2, 3 or, 4 (e.g., Table 7.3.1.1.2-2 of 3GPP TS 38.212)

| Bit field | | Bit field | | Bit field | |
|---|---|---|---|---|---|
| mapped | codebookSubset = | mapped | codebookSubset = | mapped | codebookSubset = |
| to index | fullyAndPartialAndNonCoherent | to index | partialAndNonCoherent | to index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 2 layers: TPMI = 0 | 4 | 2 layers: TPMI = 0 | 4 | 2 layers: TPMI = 0 |
| . . . | . . . | . . . | . . . | . . . | . . . |
| 9 | 2 layers: TPMI = 5 | 9 | 2 layers: TPMI = 5 | 9 | 2 layers: TPMI = 5 |
| 10 | 3 layers: TPMI = 0 | 10 | 3 layers: TPMI = 0 | 10 | 3 layers: TPMI = 0 |
| 11 | 4 layers: TPMI = 0 | 11 | 4 layers: TPMI = 0 | 11 | 4 layers: TPMI = 0 |
| 12 | 1 layer: TPMI = 4 | 12 | 1 layer: TPMI = 4 | 12-15 | reserved |
| . . . | . . . | . . . | . . . | . . . | . . . |
| 19 | 1 layer: TPMI = 11 | 19 | 1 layer: TPMI = 11 | | |
| 20 | 2 layers: TPMI = 6 | 20 | 2 layers: TPMI = 6 | | |
| . . . | . . . | . . . | . . . | | |
| 27 | 2 layers: TPMI = 13 | 27 | 2 layers: TPMI = 13 | | |
| 28 | 3 layers: TPMI = 1 | 28 | 3 layers: TPMI = 1 | | |
| 29 | 3 layers: TPMI = 2 | 29 | 3 layers: TPMI = 2 | | |
| 30 | 4 layers: TPMI = 1 | 30 | 4 layers: TPMI = 1 | | |
| 31 | 4 layers: TPMI = 2 | 31 | 4 layers: TPMI = 2 | | |
| 32 | 1 layer: TPMI = 12 | | | | |
| . . . | . . . | | | | |
| 47 | 1 layer: TPMI = 27 | | | | |
| 48 | 2 layers: TPMI = 14 | | | | |
| . . . | . . . | | | | |
| 55 | 2 layers: TPMI = 21 | | | | |
| 56 | 3 layers: TPMI = 3 | | | | |
| . . . | . . . | | | | |
| 59 | 3 layers: TPMI = 6 | | | | |
| 60 | 4 layers: TPMI = 3 | | | | |
| 61 | 4 layers: TPMI = 4 | | | | |
| 62-63 | reserved | | | | |

TABLE 2
Precoding information and number of layers, for 4 antenna ports, if transform precoding
is disabled/enabled and maxRank = 1 (e.g., Table 7.3.1.1.2-3 of 3GPP TS 38.212)

| Bit field | | Bit field | | Bit field | |
|---|---|---|---|---|---|
| mapped | codebookSubset = | mapped | codebookSubset = | mapped | codebookSubset = |
| to index | fullyAndPartialAndNonCoherent | to index | partialAndNonCoherent | to index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 1 layer: TPMI = 4 | 4 | 1 layer: TPMI = 4 | | |
| . . . | . . . | . . . | . . . | | |
| 11 | 1 layer: TPMI = 11 | 11 | 1 layer: TPMI = 11 | | |
| 12 | 1 layer: TPMI = 12 | 12-15 | reserved | | |
| . . . | . . . | | | | |
| 27 | 1 layer: TPMI = 27 | | | | |
| 28-31 | reserved | | | | |

TABLE 3
Precoding information and number of layers, for 2 antenna
ports, if transform precoding is disabled and maxRank =
2 (e.g., Table 7.3.1.1.2-4 of 3GPP TS 38.212)

| Bit field | | Bit field | |
|---|---|---|---|
| mapped | codebookSubset = | mapped | codebookSubset = |
| to index | fullyAndPartialAndNonCoherent | to index | nonCoherent |
| 0 | 1 layer: TPMI = 0 | 0 | 1 layer: TPMI = 0 |
| 1 | 1 layer: TPMI = 1 | 1 | 1 layer: TPMI = 1 |
| 2 | 2 layers: TPMI = 0 | 2 | 2 layers: TPMI = 0 |
| 3 | 1 layer: TPMI = 2 | 3 | reserved |
| 4 | 1 layer: TPMI = 3 | | |
| 5 | 1 layer: TPMI = 4 | | |
| 6 | 1 layer: TPMI = 5 | | |
| 7 | 2 layers: TPMI = 1 | | |
| 8 | 2 layers: TPMI = 2 | | |
| 9-15 | reserved | | |

TABLE 4
Precoding information and number of layers, for 2 antenna
ports, if transform precoding is disabled/enabled and
maxRank = 1 (e.g., Table 7.3.1.1.2-5 of 3GPP TS 38.212)

| Bit field | | Bit field | |
|---|---|---|---|
| mapped | codebookSubset = | mapped | codebookSubset = |
| to index | fullyAndPartialAndNonCoherent | to index | nonCoherent |
| 0 | 1 layer: TPMI = 0 | 0 | 1 layer: TPMI = 0 |
| 1 | 1 layer: TPMI = 1 | 1 | 1 layer: TPMI = 1 |
| 2 | 1 layer: TPMI = 2 | | |
| 3 | 1 layer: TPMI = 3 | | |
| 4 | 1 layer: TPMI = 4 | | |
| 5 | 1 layer: TPMI = 5 | | |
| 6-7 | reserved | | |

For a given number of layers, the TPMI field indicates a precoding matrix that the wireless device should use for PUSCH. In a first example, if the number of antenna ports is 4, the number of layers is 1, and transform precoding is disabled, then the set of possible precoding matrices is shown in Table 5. In a second example, if the number of antenna ports is 4, the number of layers is 4, and transform precoding is disabled, then the set of possible precoding matrices is shown in Table 6.

TABLE 1
Precoding matrix, W, for single-layer transmission using four antenna ports
when transform precoding is disabled (e.g., Table 6.3.1.5-3 of 3GPP TS 38.211).

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 2
Precoding matrix, W, for four-layer transmission using four antenna ports when
transform precoding is disabled (e.g., Table 6.3.1.5-7 of 3GPP TS 38.211).

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

### NCB-Based Precoding

NCB-based UL transmission is for reciprocity-based UL transmission in which SRS precoding is derived at a wireless device based on channel state information-reference signal (CSI-RS) received in the DL. Specifically, the wireless device measures received CSI-RS and deduces suitable precoder weights for SRS transmission(s), resulting in one or more (virtual) SRS ports, each corresponding to a spatial layer.

A wireless device can be configured up to four SRS resources, each with a single (virtual) SRS port, in an SRS resource set with higher-layer parameter usage in SRS-Config IE set to ‘nonCodebook’. A wireless device transmits the uplink to four SRS resources and the network node measures the UL channel based on the received SRS and determines the preferred SRS resource(s). Next, the network node indicates the selected SRS resources via the SRI field in DCI and the wireless device uses this information to precode PUSCH with a transmission rank that equals the number of indicated SRS resources (and, hence, the number of SRS ports).

### SRS

In NR, SRS is used for providing channel state information (CSI) to the network node (e.g., gNB) in the UL. The usage of SRS includes, e.g., deriving the appropriate transmission/reception beams and/or to perform link adaptation (i.e., setting the transmission rank and the MCS), and for selecting DL (e.g., for PDSCH transmissions) and UL (e.g., for PUSCH transmissions) MIMO precoding.

In LTE and NR, the SRS is configured via radio resource control (RRC), where parts of the configuration can be updated (for reduced latency) through MAC-CE signaling. The configuration includes, for example, the SRS resource allocation (the physical mapping and the sequence to use) as well as the time-domain behavior (aperiodic, semi-persistent, or periodic). For aperiodic SRS transmission, the RRC configuration does not activate an SRS transmission from the wireless device but instead a dynamic activation trigger is transmitted from the network node in the DL, via the DCI in the PDCCH which instructs the wireless device to transmit the SRS once, at a predetermined time.

When configuring SRS transmissions, the network node configures, through the SRS-Config IE, a set of SRS resources and a set of SRS resource sets, where each SRS resource set contains one or more SRS resources.

### SRS Configuration

Each SRS resource is configured with the following in RRC (e.g., ASN code in 3GPP specification such as, for example, 3GPP TS 38.331 version 16.1.0).

| SRS-Resource ::= | SEQUENCE { | |
|---|---|---|
| srs-ResourceId | SRS-ResourceId, | |
| nrofSRS-Ports | ENUMERATED {port1, ports2, ports4}, | |
| ptrs-PortIndex | ENUMERATED {n0, n1 } | OPTIONAL, -- Need |

R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, groupHopping, |

sequenceHopping },

| | |
|---|---|
| resourceType | CHOICE { |
| aperiodic | SEQUENCE { |

```
      ...
    },
```

| | |
|---|---|
| semi-persistent | SEQUENCE { |
| periodicityAndOffset-sp | SRS-PeriodicityAndOffset, |

```
      ...
    },
```

| | |
|---|---|
| periodic | SEQUENCE { |
| periodicityAndOffset-p | SRS-PeriodicityAndOffset, |

```
      ...
    }
  },
```

| sequenceId | INTEGER (0..1023), | |
|---|---|---|
| spatialRelationInfo | SRS-SpatialRelationInfo | OPTIONAL, -- Need R |

```
  ...
  [[
```

| | |
|---|---|
| resourceMapping-r16 | SEQUENCE { |
| startPosition-r16 | INTEGER (0..13), |
| nrofSymbols-r16 | ENUMERATED {n1, n2, n4}, |
| repetitionFactor-r16 | ENUMERATED {n1, n2, n4} |

| | |
|---|---|
| } | OPTIONAL -- Need |

R
]]
}

An SRS resource is configurable with respect to, e.g.,
1) The number of SRS ports (1, 2, or 4), configured by the RRC parameter nrofSRS-Ports.
2) The transmission comb (i.e., mapping to every 2nd or 4th subcarrier), configured by the RRC parameter transmissionComb, which includes:
   (1) The comb offset, configured by the RRC parameter combOffset, is specified (i.e., which of the combs that should be used).
   (2) The cyclic shift, configured by the RRC parameter cyclicShift, that configures a (port-specific, for multi-port SRS resources) cyclic shift for the Zadoff-Chu sequence that is used for SRS. The use of cyclic shifts increases the number of SRS resources that can be mapped to a comb (as SRS sequences are designed to be (almost) orthogonal under cyclic shifts), but there is a limit on how many cyclic shifts that can be used (8 for comb 2 and 12 for comb 4).
3) The time-domain position within a given slot, configured with the RRC parameter resourceMapping, which includes:
   (1) The time-domain start position, which is limited to be one of the last 6 symbols (in NR 3GPP Rel-15) or in any of the 14 symbols in a slot (in NR 3GPP Rel-16), configured by the RRC parameter startPosition.
   (2) The number of symbols for the SRS resource (that can be set to 1, 2 or 4), configured by the RRC parameter nrofSymbols.
   (3) The repetition factor (that can be set to 1, 2 or 4), configured by the RRC parameter repetitionFactor. When the repetition factor is larger than 1, the same frequency resources are used multiple times across symbols, used to improve the coverage as this allows more energy to be collected by the receiver.
4) The sounding bandwidth, frequency-domain position and shift, and frequency-hopping pattern of an SRS resource (i.e., which part of the transmission bandwidth that is occupied by the SRS resource) is set through the RRC parameters freqDomainPosition, freqDomainShift, and the freqHopping parameters c-SRS, b-SRS, and b-hop. The smallest possible sounding bandwidth is 4 RBs.
5) The RRC parameter resourceType determines whether the SRS resource is transmitted as periodic, aperiodic (single transmission triggered by DCI), or semi-persistent (same as periodic except for the start and stop of the periodic transmission is controlled through MAC-CE signaling instead of RRC signaling).
6) The RRC parameter sequenceId specifies how the SRS sequence is initialized.
7) The RRC parameter spatialRelationInfo configures the spatial relation for the SRS beam with respect to another RS (which could be another SRS, an SSB or a CSI-RS). If an SRS resource has a spatial relation to another SRS resource, then this SRS resource may be transmitted with the same beam (i.e., virtualization) as the indicated SRS resource.

An illustration of how an SRS resource could be allocated in time and frequency within a slot (note that semi-persistent/periodic SRS resources typically span several slots), is provided in FIG. 2. In NR Rel-16, the additional (and optional) RRC parameter resourceMapping-r16 was introduced. If resourceMapping-r16 is signaled, the wireless device may ignore the RRC parameter resourceMapping. The difference between resourceMapping-r16 and resourceMapping is that the SRS resource (for which the number of OFDM symbols and the repetition factor is still limited to 4) can start in any of the 14 OFDM symbols in a slot configured by the RRC parameter startPosition-r16.

An SRS resource set is configured with the following in RRC (e.g., ASN code in 3GPP TS 38.331 version 16.1.0):

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS- |
| ResourcesPerSet)) OF SRS-ResourceId | OPTIONAL, -- Cond Setup |
| resourceType | CHOICE { |
| aperiodic | SEQUENCE { |
| aperiodicSRS-ResourceTrigger | INTEGER (1..maxNrofSRS-TriggerStates- |

1),

| | | |
|---|---|---|
| csi-RS | NZP-CSI-RS-ResourceId | OPTIONAL, -- |

Cond NonCodebook

| | | |
|---|---|---|
| slotOffset | INTEGER (1..32) | OPTIONAL, -- |

```
Need S
      ...,
      [[
```

| | |
|---|---|
| aperiodicSRS-ResourceTriggerList | SEQUENCE (SIZE(1..maxNrofSRS- |

TriggerStates-2))

OF INTEGER (1..maxNrofSRS-TriggerStates-1)

```
OPTIONAL -- Need M
      ]]
    },
```

| | |
|---|---|
| semi-persistent | SEQUENCE { |
| associatedCSI-RS | NZP-CSI-RS-ResourceId |

```
OPTIONAL, -- Cond NonCodebook
      ...
    },
```

| | |
|---|---|
| periodic | SEQUENCE { |
| associatedCSI-RS | NZP-CSI-RS-ResourceId |

```
OPTIONAL, -- Cond NonCodebook
      ...
    }
  },
```

| | |
|---|---|
| usage | ENUMERATED {beamManagement, codebook, |

nonCodebook, antennaSwitching},

| | | |
|---|---|---|
| alpha | Alpha | OPTIONAL, -- Need S |
| p0 | INTEGER (−202..24) | OPTIONAL, -- |

Cond Setup

| | |
|---|---|
| pathlossReferenceRS | PathlossReferenceRS-Config |

OPTIONAL, -- Need M

| | |
|---|---|
| srs-PowerControlAdjustmentStates | ENUMERATED { sameAsFci2, |
| separateClosedLoop} | OPTIONAL, -- Need S |

```
  ...,
  [[
```

| | |
|---|---|
| pathlossReferenceRSList-r16 | SetupRelease { PathlossReferenceRSList-r16} |

OPTIONAL -- Need M
]]
}

SRS resource(s) may be transmitted as part of an SRS resource set, where all SRS resources in the same SRS resource set may be required to share the same resource type. An SRS resource set is configurable with respect to, e.g.,
8) For aperiodic SRS, the slot offset is configured by the RRC parameter slotOffset and sets the delay from the PDCCH trigger reception to the start of the SRS transmission.
9) The resource usage, which is configured by the RRC parameter usage sets constraints and assumptions on the resource properties (further details are described in 3GPP specification such as, for example, 3GPP TS 38.214). SRS resource sets can be configured with one of four different usages: ‘antennaSwitching’, ‘codebook’, ‘nonCodebook’ and ‘beamManagement’.
10) An SRS resource set that is configured with usage ‘antennaSwitching’ is used for reciprocity-based DL precoding (i.e., used to sound the channel in the UL so that the network node can use reciprocity to set a suitable DL precoders). The wireless device is expected to transmit one SRS port per wireless device antenna port.
   (1) An SRS resource set that is configured with usage ‘codebook’ is used for CB-based UL transmission (i.e., used to sound the different wireless device antennas and help the network node to determine/signal a suitable UL precoder, transmission rank, and MCS for PUSCH transmission). There are up to two SRS resources in an SRS resource set with usage ‘codebook’. How SRS ports are mapped to wireless device antenna ports is, however, up to wireless device implementation and not known to the network node.
   (2) An SRS resource set that is configured with usage ‘nonCodebook’ is used for NCB-based UL transmission. Specifically, the wireless device transmits one SRS resource per candidate beam (suitable candidate beams are determined by the wireless device based on CSI-RS measurements in the DL and, hence, reciprocity needs to hold). The network node can then, by indicating a subset of these SRS resources, determine which UL beam(s) that the wireless device should apply for PUSCH transmission. One UL layer may be transmitted per indicated SRS resource. Note that how the wireless device maps SRS ports to antenna ports is up to wireless device implementation and not known to the network node.
11) The associated CSI-RS (this configuration is only applicable for NCB-based UL transmission) for each of the possible resource types.
   (1) For an aperiodic SRS, the associated CSI-RS resource is set by the RRC parameter csi-RS.
   (2) For semi-persistent/periodic SRS, the associated CSI-RS resource is set by the RRC parameter associatedCSI-RS.
12) The PC parameters, e.g., alpha and p0 are used for setting the SRS transmission power. SRS has its own UL PC scheme in NR (e.g., further details as described in 3GPP specification such as, for example, 3GPP TS 38.213), which specifies how the wireless device may split the available output power between two or more SRS ports during one SRS transmit occasion (an SRS transmit occasion is a time window within a slot where SRS transmission is performed).

To summarize, the SRS resource-set configuration determines, e.g., usage, power control, and slot offset for aperiodic SRS. The SRS resource configuration determines the time-and-frequency allocation, the periodicity and offset, the sequence, and the spatial-relation information

### UL Power Control

Setting output power levels of transmitters, network node in downlink and mobile stations in uplink, in mobile systems is commonly referred to as power control (PC). Objectives of PC include improved capacity, coverage, improved system robustness, and reduced power consumption.

NR PC mechanisms can be categorized into the groups (i) open-loop, (ii) closed-loop, and (iii) combined open- and closed loop. These differ in what input is used to determine the transmit power. In the open-loop case, the transmitter measures some signal sent from the receiver, and sets its output power based on this. In the closed-loop case, the receiver measures the signal from the transmitter, and based on this sends a Transmit Power Control (TPC) command to the transmitter, which sets its transmit power accordingly. In a combined open- and closed-loop scheme, both inputs are used to set the transmit power.

In systems with multiple channels between the terminals and the network node, e.g., traffic and control channels, different power control principles may be applied to the different channels. Using different principles yields more freedom in adapting the power control principle to the needs of individual channels. The drawback is increased complexity of maintaining several principles.

### PUSCH Power Control and Power Scaling in NR

NR power control for UL MIMO can be thought of as having two components: first determining a total transmission power P_{PUSCH,b,f,c}(i, j, q_{d}, l), and then scaling and dividing that power among antenna ports carrying the PUSCH. The power P_{PUSCH,b,f,c}(i, j, q_{d}, l) is calculated according to section 7.1.1 of 3GPP TS 38.213 v16.6.0 using the equation from the excerpt below:

### UE Behavior

If a wireless device transmits a PUSCH on active UL BWP b of carrier f of serving cell c using parameter set configuration with index j and PUSCH power control adjustment state with index l, the wireless device determines the PUSCH transmission power P_{PUSCH,b,f,c}(i, j, q_{d}, l) in PUSCH transmission occasion i as

$${P}_{PUSCH , b , f , c} ( i , j , {q}_{d} , l ) = min \{ \begin{matrix}{P}_{CMAX , f , c} ( i ) , \\ {P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} [ dBm ]$$

According to 3GPP standard such as, for example, section 7.1 of 3GPP TS 38.213, this total transmission power is converted from decibels to the linear power value \hat{P}_{PUSCH,b,f,c}(i, j, q_{d}, l). This power is then scaled by a factor s≤1 if a full power mode is configured, to account for the power available on each Tx chain. If an uplink full power mode is not configured, but codebook-based operation is used, the power is scaled by the number of ports actively carrying the PUSCH divided by the maximum number of SRS ports in one SRS resource that is supported by the wireless device (i.e., the number of Tx chains in the wireless device on the carrier). If DCI format 0_0 or non-codebook-based precoding is used, the power is not scaled.

After the scaling, if any, is applied, the power is split equally among the antenna ports that the UE transmits the PUSCH on.

It can be observed that NR power control as described above divides the power equally among PUSCH layers. Furthermore, there is a single number of occupied PRBs PUSCH for a PUSCH transmission, M_{RB,b,f,c}^{PUSCH} that is used to scale the power up in the power control equation. Cases where a PUSCH layer is in a set of PRBs that are different from those in another layer is not supported in NR as of Rel-17 in general, and here specifically for power control and power scaling. Hence, some existing systems are not without issues.

### SUMMARY

Some embodiments advantageously provide methods, systems, and apparatuses for multi-resource transmission with, for example, transmission power scaling and virtualization.

Codebook based UL transmission for wireless devices with more than 4 transmission ports is supported by transmitting layers according to multiple SRS resources simultaneously, where a distinct precoder is applied to each of the multiple SRS resources and different layers may be precoded by the precoders. The number of ports supported for simultaneous transmission is the combined number of ports in the SRS resources. This allows both a larger number of Tx chains to be supported in the wireless device as well as an increased number of layers beyond what is in Rel-17. One focus of the present disclosure is on how power is divided within and between the sets of Tx chains corresponding to the different SRS resources (i.e., on ‘power scaling’), and on how Tx chains can be virtualized to provide more power or precoding gain. Additional aspects include how to map layers to transmit them coherently or noncoherently across the antenna ports corresponding to the SRS resources, as well as how to carry different codewords on the different sets of layers corresponding to the SRS resources.

According to one aspect of the present disclosure, a network node in communication with a wireless device is provided. The network node includes processing circuitry configured to: configure the wireless device with a plurality of SRS resources, cause transmission of a first indication of a first precoder for use with a first antenna port signal set that carries a first portion of a physical channel and is associated with a first SRS resource of the plurality of SRS resources, cause transmission of a second indication of a second precoder for use with a second antenna port signal set that carries a second portion of the physical channel and is associated with a second SRS resource of the plurality of SRS resources, and receive transmission of the physical channel, the first and second physical channel portion being based on the first and second indications, respectively, for forming a first and second signal power, each antenna port signal in the first antenna port signal set being based on a number of antenna ports of the first antenna port signal set with non-zero power, each antenna port signal in the second antenna port signal set being based on a number of antenna ports of the second antenna port signal set with non-zero power.

According to some embodiments of this aspect, a total configured signal power for the physical channel is based on dividing either equally or unequally across either: the antenna port signals in the first antenna port signal set with non-zero power; or among ports corresponding to each resource, the dividing being based on either a controlled ratio of the first and second power signals or power control parameters for independent control of the first and second power signals.

According to some embodiments of this aspect, the physical channel comprises: a first set of transmission layers precoded with the first precoder to generate the first antenna port signal set corresponding to the first physical channel portion, a second set of transmission layers precoded with the second precoder to generate the second antenna port signal set corresponding to the second physical channel portion, the first signal power being based at least in part on a multiplication of a power of each antenna port signal in the first antenna port signal set by a number of antenna ports with non-zero power in the first antenna port signal set, and the second signal power being based at least in part on a multiplication of a power of each antenna port signal of the second antenna port signal set by a number of antenna ports with non-zero power in the second antenna port signal set.

According to some embodiments of this aspect, the first and the second layer set of transmission layers are mapped to a first and second set of DMRS ports, wherein the first set of DMRS ports corresponds only to the first set of transmission layers, and the second set of DMRS ports corresponds only to the second set of transmission layers.

According to some embodiments of this aspect, each of the first SRS resource and second SRS resource contains less than N ports where N is a value corresponding to one of a maximum number of transmission layers and maximum number of SRS ports that the wireless device can transmit.

According to some embodiments of this aspect, the first and second signal powers are based on dividing the first and second signal powers by N.

According to some embodiments of this aspect, the first and second signal powers are based on dividing the first and second signals powers by a first and a second number of SRS ports, respectively, wherein the first and second number of SRS ports are the number of SRS ports in the first and second SRS resources, respectively, the first signal powers being split equally among the antenna ports signals of the first antenna port signal set, and the second signal powers being split equally among the antenna ports signals of the second antenna port signal set.

According to some embodiments of this aspect, the physical channel signaling corresponds to a physical uplink shared channel.

According to another aspect of the present disclosure, a wireless device in communication with a network node is provided. The wireless device includes processing circuitry configured to: receive signaling for configuring the wireless device with a plurality of SRS resources, receive a first indication of a first precoder for use with a first antenna port signal set that carries a first portion of a physical channel and is associated with a first SRS resource of the plurality of SRS resources, receive a second indication of a second precoder for use with a second antenna port signal set that carries a second portion of the physical channel and is associated with a second SRS resource of the plurality of SRS resources, adjust the first and second physical channel portion according to the first and second indications, respectively, forming a first and second signal power, each antenna port signal in the first antenna port signal set being adjusted by a number of antenna ports of the first antenna port signal set with non-zero power, each antenna port signal in the second antenna port signal set adjusted by a number of antenna ports of the second antenna port signal set with non-zero power; and cause transmission of the physical channel.

According to some embodiments of this aspect, a total configured signal power for the physical channel is divided either equally or unequally across either: the antenna port signals in the first antenna port signal set with non-zero power; or among ports corresponding to each resource, the division being based on either a controlled ratio of the first and second power signals or power control parameters for independent control of the first and second power signals.

According to some embodiments of this aspect, the processing circuitry is further configured to: precode a first set of transmission layers with the first precoder to generate the first antenna port signal set corresponding to the first physical channel portion; precode a second set of transmission layers with the second precoder to generate the second antenna port signal set corresponding to the second physical channel portion; adjust the first signal power at least in part by multiplying a power of each antenna port signal in the first antenna port signal set by a number of antenna ports with non-zero power in the first antenna port signal set, and adjust the second signal power at least in part by multiplying a power of each antenna port signal of the second antenna port signal set by a number of antenna ports with non-zero power in the second antenna port signal set.

According to some embodiments of this aspect, the processing circuitry is further configured to map the first and the second layer set of transmission layers to a first and second set of DMRS ports, wherein the first set of DMRS ports corresponds only to the first set of transmission layers, and the second set of DMRS ports corresponds only to the second set of transmission layers.

According to some embodiments of this aspect, each of the first SRS resource and second SRS resource contains less than N ports where N is a value corresponding to one of a maximum number of transmission layers and maximum number of SRS ports that the wireless device can transmit.

According to some embodiments of this aspect, the processing circuitry is further configured to additionally adjust the first and second signal powers by dividing the first and second signal powers by N.

According to some embodiments of this aspect, the processing circuitry is further configured to: additionally adjust the first and second signal powers by dividing the first and second signals powers by a first and a second number of SRS ports, respectively, wherein the first and second number of SRS ports are the number of SRS ports in the first and second SRS resources, respectively; split the adjusted first signal powers equally among the antenna ports signals of the first antenna port signal set; and split the adjusted second signal powers equally among the antenna ports signals of the second antenna port signal set.

According to some embodiments of this aspect, the physical channel signaling corresponds to a physical uplink shared channel.

According to another aspect of the present disclosure, a method implemented by a network node that is in communication with a wireless device is provided. The method includes configuring the wireless device with a plurality of SRS resources, causing transmission of a first indication of a first precoder for use with a first antenna port signal set that carries a first portion of a physical channel and is associated with a first SRS resource of the plurality of SRS resources, causing transmission of a second indication of a second precoder for use with a second antenna port signal set that carries a second portion of the physical channel and is associated with a second SRS resource of the plurality of SRS resources and receiving transmission of the physical channel, the first and second physical channel portion being based on the first and second indications, respectively, for forming a first and second signal power, each antenna port signal in the first antenna port signal set being based on a number of antenna ports of the first antenna port signal set with non-zero power, each antenna port signal in the second antenna port signal set being based on a number of antenna ports of the second antenna port signal set with non-zero power.

According to some embodiments of this aspect, a total configured signal power for the physical channel is based on dividing either equally or unequally across either: the antenna port signals in the first antenna port signal set with non-zero power; or among ports corresponding to each resource, the dividing being based on either a controlled ratio of the first and second power signals or power control parameters for independent control of the first and second power signals.

According to some embodiments of this aspect, the physical channel comprises: a first set of transmission layers precoded with the first precoder to generate the first antenna port signal set corresponding to the first physical channel portion; a second set of transmission layers precoded with the second precoder to generate the second antenna port signal set corresponding to the second physical channel portion; the first signal power being based at least in part on a multiplication of a power of each antenna port signal in the first antenna port signal set by a number of antenna ports with non-zero power in the first antenna port signal set, and the second signal power being based at least in part on a multiplication of a power of each antenna port signal of the second antenna port signal set by a number of antenna ports with non-zero power in the second antenna port signal set.

According to some embodiments of this aspect, the first and the second layer set of transmission layers are mapped to a first and second set of DMRS ports, wherein the first set of DMRS ports corresponds only to the first set of transmission layers, and the second set of DMRS ports corresponds only to the second set of transmission layers.

According to some embodiments of this aspect, each of the first SRS resource and second SRS resource contains less than N ports where N is a value corresponding to one of a maximum number of transmission layers and maximum number of SRS ports that the wireless device can transmit.

According to some embodiments of this aspect, the first and second signal powers are based on dividing the first and second signal powers by N.

According to some embodiments of this aspect, the first and second signal powers are based on dividing the first and second signals powers by a first and a second number of SRS ports, respectively, wherein the first and second number of SRS ports are the number of SRS ports in the first and second SRS resources, respectively, the first signal powers being split equally among the antenna ports signals of the first antenna port signal set, and the second signal powers being split equally among the antenna ports signals of the second antenna port signal set.

According to some embodiments of this aspect, the physical channel signaling corresponds to a physical uplink shared channel.

According to another aspect of the present disclosure, a method implemented by a wireless device that is in communication with a network node is provided. The method includes receiving signaling for configuring the wireless device with a plurality of SRS resources, receiving a first indication of a first precoder for use with a first antenna port signal set that carries a first portion of a physical channel and is associated with a first SRS resource of the plurality of SRS resources, receiving a second indication of a second precoder for use with a second antenna port signal set that carries a second portion of the physical channel and is associated with a second SRS resource of the plurality of SRS resources, adjusting the first and second physical channel portion according to the first and second indications, respectively, forming a first and second signal power, each antenna port signal in the first antenna port signal set being adjusted by a number of antenna ports of the first antenna port signal set with non-zero power, each antenna port signal in the second antenna port signal set adjusted by a number of antenna ports of the second antenna port signal set with non-zero power; and causing transmission of the physical channel.

According to some embodiments of this aspect, a total configured signal power for the physical channel is divided either equally or unequally across either: the antenna port signals in the first antenna port signal set with non-zero power; or among ports corresponding to each resource, the division being based on either a controlled ratio of the first and second power signals or power control parameters for independent control of the first and second power signals.

According to some embodiments of this aspect, the method further includes precoding a first set of transmission layers with the first precoder to generate the first antenna port signal set corresponding to the first physical channel portion; precoding a second set of transmission layers with the second precoder to generate the second antenna port signal set corresponding to the second physical channel portion; adjusting the first signal power at least in part by multiplying a power of each antenna port signal in the first antenna port signal set by a number of antenna ports with non-zero power in the first antenna port signal set; and adjusting the second signal power at least in part by multiplying a power of each antenna port signal of the second antenna port signal set by a number of antenna ports with non-zero power in the second antenna port signal set.

According to some embodiments of this aspect, the method further includes mapping the first and the second layer set of transmission layers to a first and second set of DMRS ports, wherein the first set of DMRS ports corresponds only to the first set of transmission layers, and the second set of DMRS ports corresponds only to the second set of transmission layers.

According to some embodiments of this aspect, each of the first SRS resource and second SRS resource contains less than N ports where N is a value corresponding to one of a maximum number of transmission layers and maximum number of SRS ports that the wireless device can transmit.

According to some embodiments of this aspect, the method further includes additionally adjusting the first and second signal powers by dividing the first and second signal powers by N.

According to some embodiments of this aspect, the method further includes additionally adjusting the first and second signal powers by dividing the first and second signals powers by a first and a second number of SRS ports, respectively, wherein the first and second number of SRS ports are the number of SRS ports in the first and second SRS resources, respectively; splitting the adjusted first signal powers equally among the antenna ports signals of the first antenna port signal set; and splitting the adjusted second signal powers equally among the antenna ports signals of the second antenna port signal set.

According to some embodiments of this aspect, the physical channel signaling corresponds to a physical uplink shared channel.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a CB-based precoding;

FIG. 2 is a diagram of an allocation in time and frequency within a lost if resourceMapping-r16 is not signaled;

FIG. 3 is a schematic diagram of an example network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node according to some embodiments of the present disclosure;

FIG. 10 is a flowchart of another example process in a network node according to some embodiments of the present disclosure;

FIG. 11 is a flowchart of an example process in a wireless device according to some embodiments of the present disclosure;

FIG. 12 is a flowchart of another example process in a wireless device according to some embodiments of the present disclosure;

FIG. 13 is a diagram of multi-SRS resource transmission with precoding per SRS resource;

FIG. 14 is a diagram of multi-SRS resource transmission where a layer can be mapped to different resources; and

FIG. 15 is a diagram of multi-SRS resource transmission using multiple codewords.

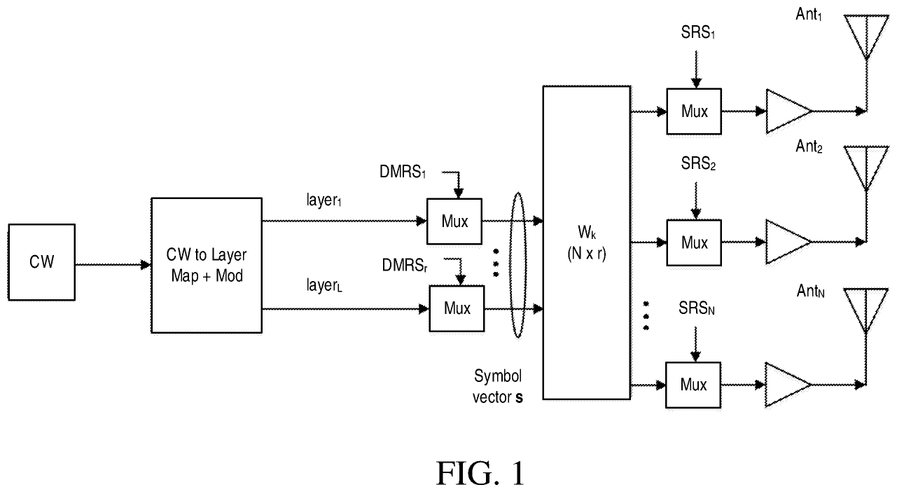

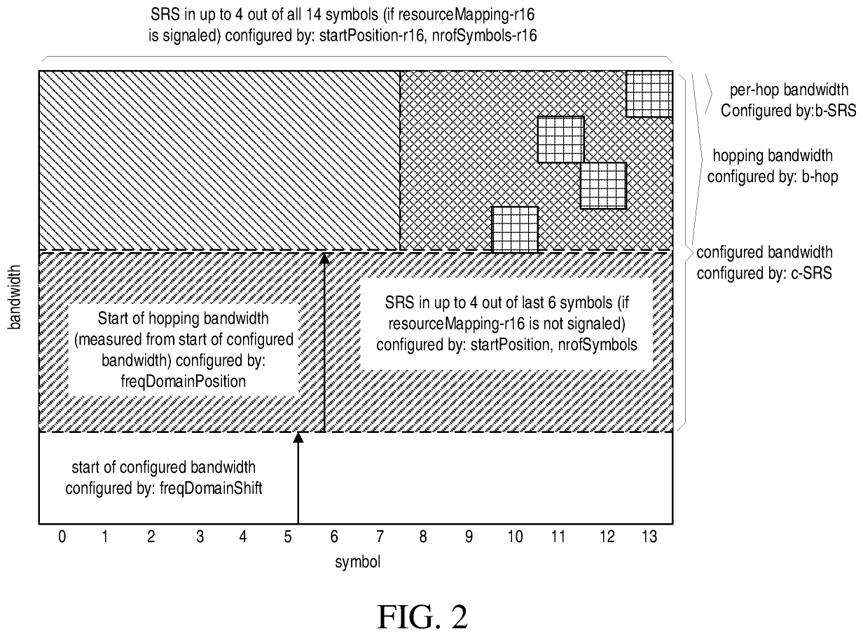

### DETAILED DESCRIPTION

As explained above, legacy NR CB-based UL transmission is limited to up to 4 ports (and up to 4 layers). For 3GPP NR Rel-18, it is discussed to support up to 8 ports (and, possibly, more than 4 layers) for UL transmission. Specifically, the 3GPP NR Rel-18 work item description includes the following objective.

### Considerations:

Study, and if justified, specify UL DMRS, SRS, SRI, and TPMI (including codebook) enhancements to enable 8 Tx UL operation to support 4 and more layers per wireless device in UL targeting CPE/FWA/vehicle/Industrial devices.
Note: Potential restrictions on the scope of this objective (including coherence assumption, full/non-full power modes) will be identified as part of the study.

In one example system, a wireless device transmits MIMO layers on different antenna subsets, using indicated precoders on antennas of the wireless device associated with each of indicated RS resources. This allows a wireless device to transmit using more ports or more layers than for a single SRS resource of the same size. However, this example system does not address how to scale power among antennas or SRS resources, nor describe virtualization approaches, nor other details of layer mapping and codeword to layer mapping.

In another example system, SRS enhancements for sounding 6 and 8 Tx wireless devices was presented. However, how the network node should configure precoding matrix and transmission rank for such wireless devices is not described.

One or more embodiments described herein solve at least a portion of one or more issues with existing systems. In one or more embodiments, power can be allocated in a way suitable to wireless devices with limited power capabilities on each Tx chain, for example where each Tx chain's power capability is Pmax/N, where Pmax is the rated power of the wireless device and N is the number of Tx chains in the wireless device.

Methods herein prevent that the power required would be exceeded for any given Tx chain. Methods are also provided that allow the power to be controlled between sets of Tx chains (‘panels’) in the wireless device, in order to better control the SNR received from the panels by one or more network nodes. Power may also be shared among panels by mapping layers to more than one panel. Antennas in a panel can be virtualized to provide more power per antenna port. Multiple codewords can be carried on the different panels to better match the received SNR of those panels

Before describing in detail example embodiments, it is noted that the embodiments reside primarily in combinations of apparatus components and processing steps related to multi-resource transmission with, for example, transmission power scaling and virtualization. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide multi-resource transmission with, for example, transmission power scaling and virtualization.

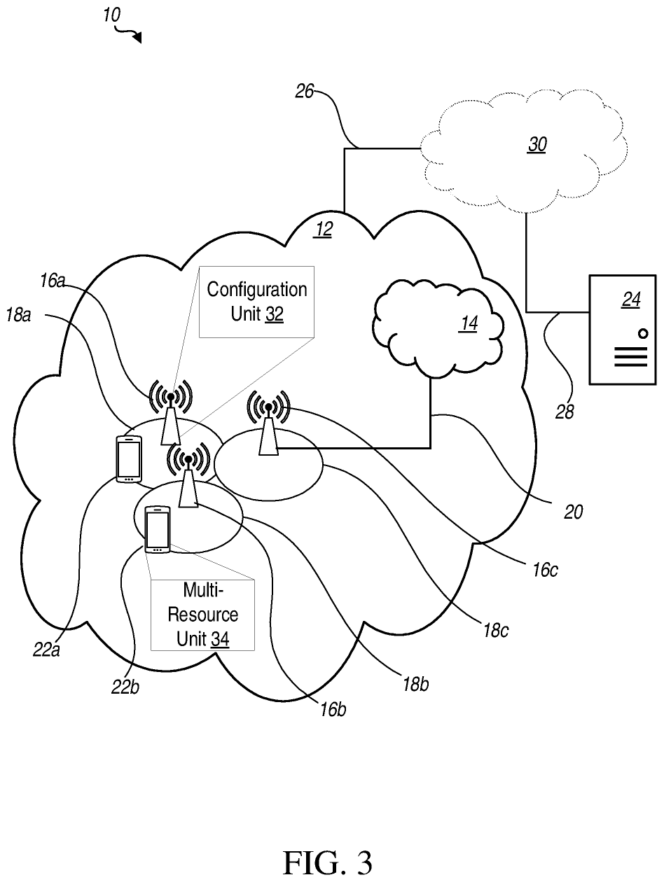

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to perform one or more network node 16 functions described herein such as with respect to multi-resource transmission with, for example, transmission power scaling and virtualization. A wireless device 22 is configured to include a multi-resource unit 34 which is configured to perform one or more wireless device 22 functions described herein such as with respect to multi-resource transmission with, for example, transmission power scaling and virtualization.

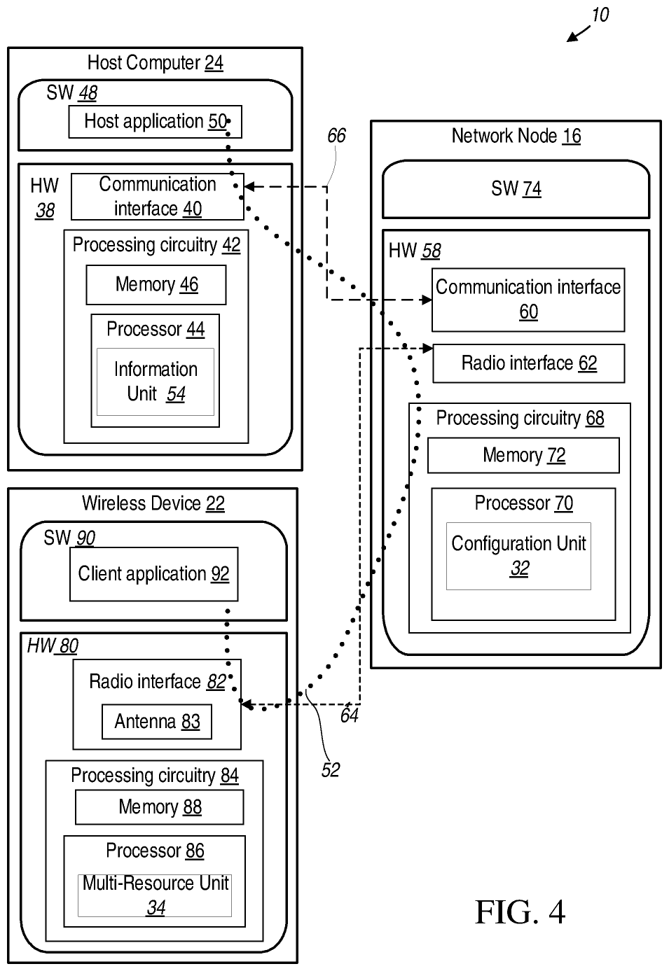

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more of: store, analyze, forward, relay, transmit, receive, communicate, configure, etc., information related to multi-resource transmission with, for example, transmission power scaling and virtualization that is described herein.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to perform one or more network node 16 functions as described herein such as with respect to multi-resource transmission with, for example, transmission power scaling and virtualization.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters (e.g., transmitter chains/panels), one or more RF receivers (e.g., receiver chains/panels), and/or one or more RF transceivers. Radio interface 82 may include one or more antenna 83 (e.g., one or more antenna ports).

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a multi-resource unit 34 configured to perform one or more wireless device 22 functions described herein such as with respect to multi-resource transmission with, for example, transmission power scaling and virtualization.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as configuration unit 32, and multi-resource unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

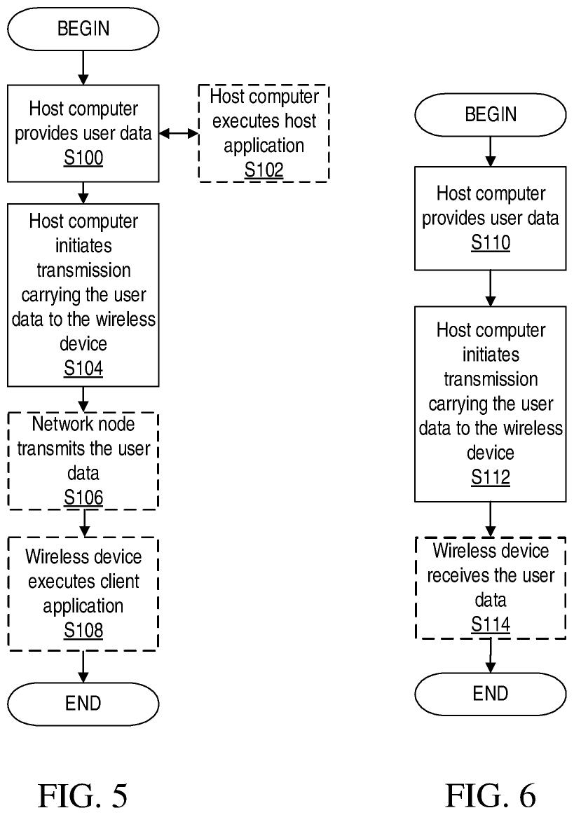

FIG. 5 is a flowchart illustrating an example method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

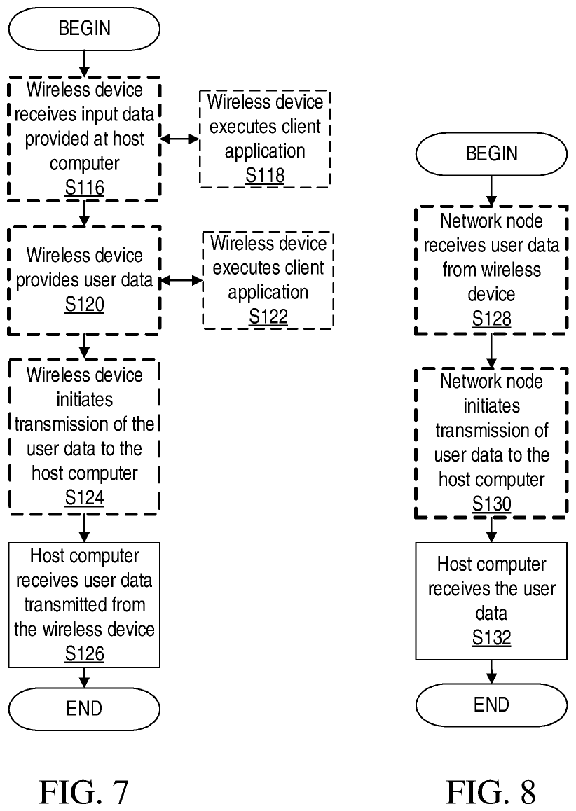

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

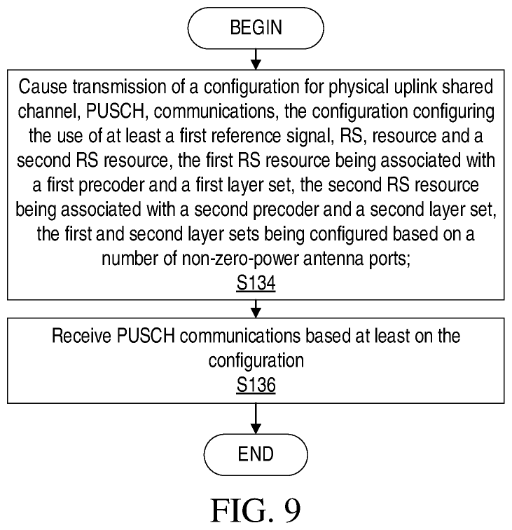

FIG. 9 is a flowchart of an example process in a network node 16 according to one or more embodiments of the present disclosure. One or more blocks described herein may be performed by one or more elements of network node 16 such as by one or more of processing circuitry 68 (including the configuration unit 32), processor 70, radio interface 62 and/or communication interface 60. Network node 16 is configured to cause (Block S134) transmission of a configuration for physical uplink shared channel, PUSCH, communications where the configuration configures the use of at least a first reference signal, RS, resource and a second RS resource, and the first RS resource is associated with a first precoder and a first layer set, the second RS resource being associated with a second precoder and a second layer set, the first and second layer sets being configured based on a number of non-zero-power antenna ports, as described herein. Network node 16 is configured to receive (Block S136) PUSCH communications based at least on the configuration, as described herein.

According to one or more embodiments, the first and second RS resources each includes less than N ports where N corresponds to one of a maximum number of layers and a maximum number of RS ports that the wireless device is configurable to transmit with. According to one or more embodiments, each of the first layer set and second layer set corresponding to a portion of total transmitted power. According to one or more embodiments, a transmission power associated with the received PUSCH is based on: scaling down the transmission power by a number of RS ports in each of the first RS resource and second RS resource to allow for dynamically virtualization; and splitting the scaled down transmission power equally across at least non-zero antenna ports.

According to one or more embodiments, a transmission power associated with the received PUSCH is based on: scaling down the transmission power by a total number of one of layers and ports supported by the wireless device when dynamic virtualization is not used; and splitting the scaled down transmission power equally across at least non-zero ports. According to one or more embodiments, the splitting is based on one of: a split across non-zero ports for each of the first and second RS resources; and a split equally among all transmitted ports.

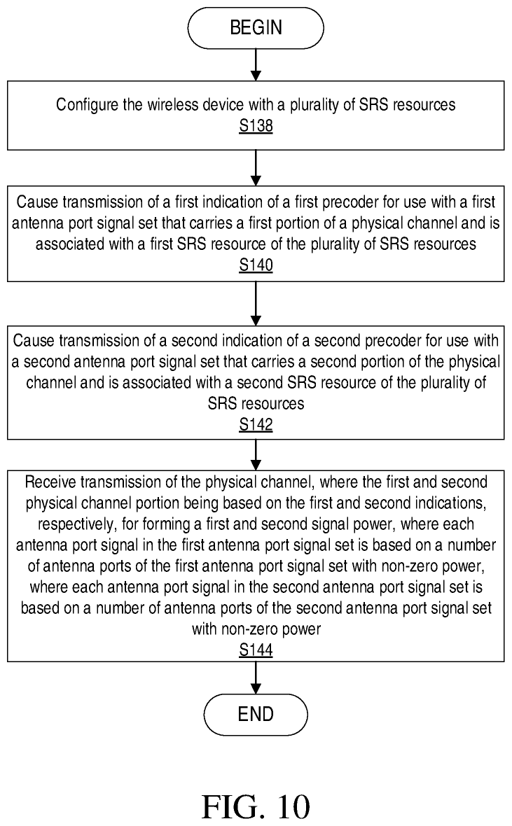

FIG. 10 is a flowchart of another example process in a network node 16 according to one or more embodiments of the present disclosure. One or more blocks described herein may be performed by one or more elements of network node 16 such as by one or more of processing circuitry 68 (including the configuration unit 32), processor 70, radio interface 62 and/or communication interface 60. Network node 16 is configured to configure (Block S138) the wireless device with a plurality of SRS resources, as described herein.

Network node 16 is configured to cause (Block S140) transmission of a first indication of a first precoder for use with a first antenna port signal set that carries a first portion of a physical channel and is associated with a first SRS resource of the plurality of SRS resources, as described herein.

Network node 16 is configured to cause (Block S142) transmission of a second indication of a second precoder for use with a second antenna port signal set that carries a second portion of the physical channel and is associated with a second SRS resource of the plurality of SRS resources, as described herein.

Network node 16 is configured to receive (Block S144) transmission of the physical channel, where the first and second physical channel portion is based on the first and second indications, respectively, for forming a first and second signal power, where each antenna port signal in the first antenna port signal set is based on a number of antenna ports of the first antenna port signal set with non-zero power, where each antenna port signal in the second antenna port signal set is based on a number of antenna ports of the second antenna port signal set with non-zero power, as described herein.

According to some embodiments, a total configured signal power for the physical channel is based on dividing either equally or unequally across either: the antenna port signals in the first antenna port signal set with non-zero power; or among ports corresponding to each resource, the dividing being based on either a controlled ratio of the first and second power signals or power control parameters for independent control of the first and second power signals.

According to some embodiments, the physical channel comprises: a first set of transmission layers precoded with the first precoder to generate the first antenna port signal set corresponding to the first physical channel portion, a second set of transmission layers precoded with the second precoder to generate the second antenna port signal set corresponding to the second physical channel portion, the first signal power being based at least in part on a multiplication of a power of each antenna port signal in the first antenna port signal set by a number of antenna ports with non-zero power in the first antenna port signal set, and the second signal power being based at least in part on a multiplication of a power of each antenna port signal of the second antenna port signal set by a number of antenna ports with non-zero power in the second antenna port signal set.

According to some embodiments, the first and the second layer set of transmission layers are mapped to a first and second set of DMRS ports, wherein the first set of DMRS ports corresponds only to the first set of transmission layers, and the second set of DMRS ports corresponds only to the second set of transmission layers.

According to some embodiments, each of the first SRS resource and second SRS resource contains less than N ports where N is a value corresponding to one of a maximum number of transmission layers and maximum number of SRS ports that the wireless device can transmit.

According to some embodiments, the first and second signal powers are based on dividing the first and second signal powers by N.

According to some embodiments, the first and second signal powers are based on dividing the first and second signals powers by a first and a second number of SRS ports, respectively, wherein the first and second number of SRS ports are the number of SRS ports in the first and second SRS resources, respectively, the first signal powers being split equally among the antenna ports signals of the first antenna port signal set, and the second signal powers being split equally among the antenna ports signals of the second antenna port signal set.

According to some embodiments, the physical channel signaling corresponds to a physical uplink shared channel.

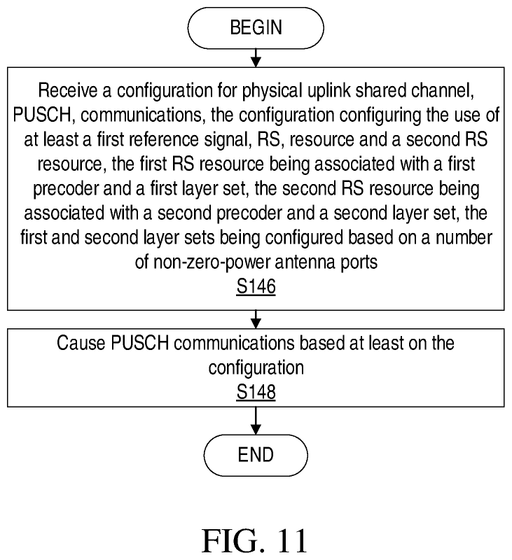

FIG. 11 is a flowchart of an example process in a wireless device 22 according to some embodiments of the present disclosure. One or more blocks described herein may be performed by one or more elements of wireless device 22 such as by one or more of processing circuitry 84 (including the multi-resource unit 34), processor 86, radio interface 82 and/or communication interface 60. Wireless device 22 is configured to receive (Block S146) a configuration for physical uplink shared channel, PUSCH, communications where the configuration configures the use of at least a first reference signal, RS, resource and a second RS resource, and the first RS resource is associated with a first precoder and a first layer set, and the second RS resource is associated with a second precoder and a second layer set, where the first and second layer sets are configured based on a number of non-zero-power antenna ports, as described herein. Wireless device 22 is configured to cause (Block S148) PUSCH communications based at least on the configuration, as described herein.

According to one or more embodiments, the first and second RS resources each includes less than N ports where N corresponds to one of a maximum number of layers and a maximum number of RS ports that the wireless device 22 is configurable to transmit with. According to one or more embodiments, each of the first layer set and second layer set corresponding to a portion of total transmitted power. According to one or more embodiments, a transmission power associated with the transmitted PUSCH is based on: scaling down the transmission power by a number of RS ports in each of the first RS resource and second RS resource to allow for dynamically virtualization; and splitting the scaled down transmission power equally across at least non-zero antenna ports.

According to one or more embodiments, a transmission power associated with the transmitted PUSCH is based on: scaling down the transmission power by a total number of one of layers and ports supported by the wireless device when dynamic virtualization is not used; and splitting the scaled down transmission power equally across at least non-zero ports. According to one or more embodiments, the splitting is based on one of: a split across non-zero ports for each of the first and second RS resources; and a split equally among all transmitted ports.

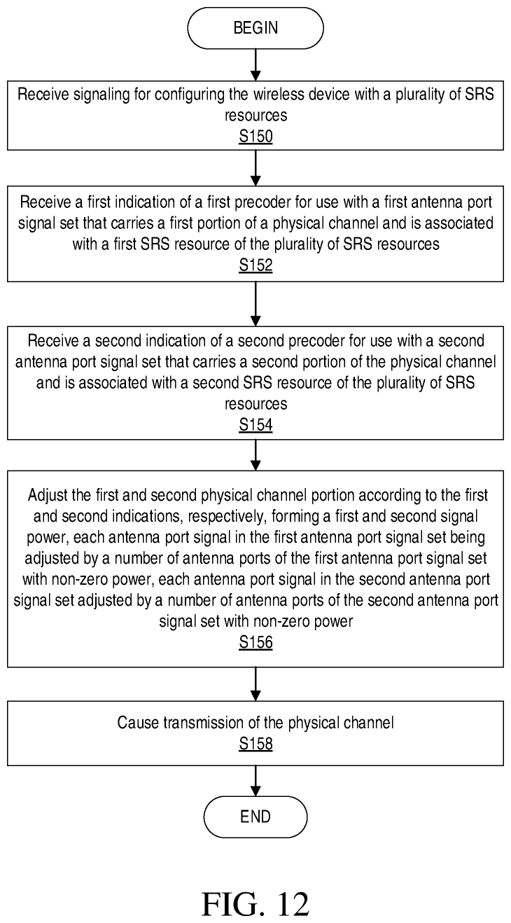

FIG. 12 is a flowchart of another example process in a wireless device 22 according to some embodiments of the present disclosure. One or more blocks described herein may be performed by one or more elements of wireless device 22 such as by one or more of processing circuitry 84 (including the multi-resource unit 34), processor 86, radio interface 82 and/or communication interface 60. Wireless device 22 is configured to receive (Block S150) receive signaling for configuring the wireless device with a plurality of SRS resources, as described herein. Wireless device 22 is configured to receive (Block S152) a first indication of a first precoder for use with a first antenna port signal set that carries a first portion of a physical channel and is associated with a first SRS resource of the plurality of SRS resources, as described herein.

Wireless device 22 is configured to receive (Block S154) a second indication of a second precoder for use with a second antenna port signal set that carries a second portion of the physical channel and is associated with a second SRS resource of the plurality of SRS resources, as described herein. Wireless device 22 is configured to adjust (Block S156) the first and second physical channel portion according to the first and second indications, respectively, forming a first and second signal power, where each antenna port signal in the first antenna port signal set is adjusted by a number of antenna ports of the first antenna port signal set with non-zero power, where each antenna port signal in the second antenna port signal set is adjusted by a number of antenna ports of the second antenna port signal set with non-zero power, as described herein. Wireless device 22 is configured to cause (Block S158) transmission of the physical channel.

According to some embodiments, the processing circuitry 84 is further configured to: precode a first set of transmission layers with the first precoder to generate the first antenna port signal set corresponding to the first physical channel portion; precode a second set of transmission layers with the second precoder to generate the second antenna port signal set corresponding to the second physical channel portion; adjust the first signal power at least in part by multiplying a power of each antenna port signal in the first antenna port signal set by a number of antenna ports with non-zero power in the first antenna port signal set, and adjust the second signal power at least in part by multiplying a power of each antenna port signal of the second antenna port signal set by a number of antenna ports with non-zero power in the second antenna port signal set.

According to some embodiments, the processing circuitry 84 is further configured to map the first and the second layer set of transmission layers to a first and second set of DMRS ports, wherein the first set of DMRS ports corresponds only to the first set of transmission layers, and the second set of DMRS ports corresponds only to the second set of transmission layers.

According to some embodiments, each of the first SRS resource and second SRS resource contains less than N ports where N is a value corresponding to one of a maximum number of transmission layers and maximum number of SRS ports that the wireless device can transmit.

According to some embodiments, the processing circuitry 84 is further configured to additionally adjust the first and second signal powers by dividing the first and second signal powers by N.

According to some embodiments, the processing circuitry 84 is further configured to: additionally adjust the first and second signal powers by dividing the first and second signals powers by a first and a second number of SRS ports, respectively, wherein the first and second number of SRS ports are the number of SRS ports in the first and second SRS resources, respectively; split the adjusted first signal powers equally among the antenna ports signals of the first antenna port signal set; and split the adjusted second signal powers equally among the antenna ports signals of the second antenna port signal set.

According to some embodiments, the physical channel signaling corresponds to a physical uplink shared channel.

Having described the general process flow of arrangements of the disclosure and having provided examples of hardware and software arrangements for implementing the processes and functions of the disclosure, the sections below provide details and examples of arrangements for multi-resource transmission with, for example, transmission power scaling and virtualization.

Some embodiments provide multi-resource transmission with, for example, transmission power scaling and virtualization. One or more wireless device 22 functions described below may be performed by one or more of processing circuitry 84, processor 86, multi-resource unit 34, radio interface 82, antenna 83, etc. One or more network node 16 functions described below may be performed by one or more of processing circuitry 68, processor 70, configuration unit 32, etc.

As discussed above, 3GPP Rel-15 NR supports codebook based UL MIMO operation where DCI can select a single SRS resource and a precoder to be used to transmit one or more PUSCH layers. Non-codebook based operation is also supported for 3GPP Rel-15 NR UL MIMO, where an SRI indicates one or more single port SRS resources to be used to transmit a corresponding one or more PUSCH layers. As of 3GPP Rel-17, NR UL MIMO does not support codebook based or non-codebook based operation where multiple multi-port SRS resources are used to transmit PUSCH layers.

There are various benefits to supporting multi-SRS-resource, multi-SRS-port transmission. If distinct PUSCH layers are associated with each SRS resource, simultaneous transmission using multiple SRS resources increases the number of transmitted layers. Compared to 3GPP Rel-15 non-codebook based operation (which also increases the number of layers), the use of a multi-port SRS resource allows the network node 16 to select a precoder for each resource that can optimize the received signal at the network node 16, allowing better tracking of fast fading and with reduced wireless device 22 complexity than wireless device reciprocity based approaches often assumed for non-codebook based schemes. Compared to Rel-15 codebook based operation, an Nₛᵣₛ SRS-resource transmission with Nₚₒᵣₜ SRS ports each can comprise Nₛᵣₛ*Nₚₒᵣₜ=N antenna elements, where elements in a panel have a same antenna pattern, but each panel has different antenna patterns and/or boresights. This grouping of array elements into panels can result in similar received power at a TRP for elements in a panel, and different power for elements in different panels. These different received power levels can make it beneficial to assign a common parameter for transmissions from the panel for the purpose of link adaptation. For example, it can be beneficial to adjust the power on a per panel basis to better tradeoff the total transmit power versus the SINR of layers from each panel, thereby improving UL throughput. Similarly, if a different modulation and/or different code rate is used for each panel, the channel capacity of the layers in each panel can be more closely matched.

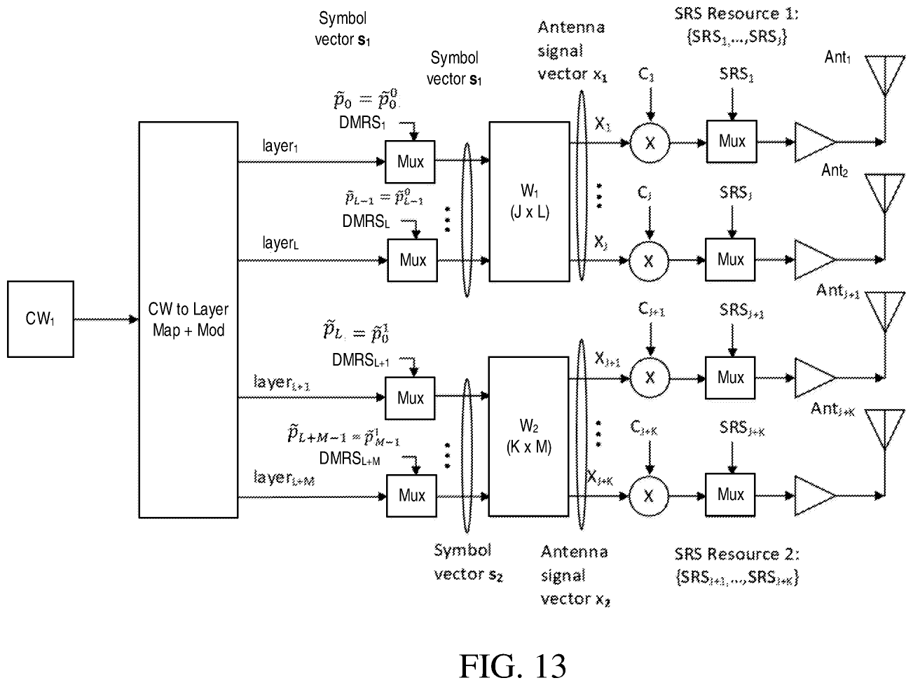

Some embodiments of multi-SRS resource based multi-SRS port transmission are described with respect to the example block diagram FIG. 13:

Unlike 3GPP Rel-15 NR, two distinct precoders W₁ and W₂ are used when transmitting a single physical channel. In this example, a single codeword is transmitted and mapped to two distinct sets of layers, or ‘layer sets’, identified by symbols vectors s₁ and s₂, respectively. The first layer set, corresponding to $1 has L layers (and so rank L), while the second layer set, corresponding to s₂ has M layers (and so rank M). Precoders W₁ and W₂ therefore are matrices with J rows and L columns and K rows and M columns, respectively. Each layer of each layer set is multiplexed with a DMRS identified by a DMRS port and that is unique to that layer. The first and second precoders produce antenna port signal vectors x₁ and x₂, respectively, according to:
W₁s₁=x₁ and W₂s₂=x₂

A total of J+K=N antennas are illustrated. There are J antenna port signals X₁ . . . X_{J} in the first set of antenna port signals, and K antenna port signal X_{J+1} . . . X_{J+K} in the second set of antenna port signals. Each antenna port signal corresponds to one of J+K antennas. An SRS signal specific to each of the J+K antennas (one of {SRS₁, . . . , SRS_{J+K}}) is multiplexed on the same antenna as its corresponding antenna port signal, thereby allowing channel estimation for signals carried on the antenna through measurements of the SRS signal.

The power transmitted through each antenna is adjusted by a multiplier C₁ . . . C_{J} for the first set of antennas and antenna port signals, and C_{J+1} . . . C_{J+K} for the second set of antennas and antenna port signals. In this way, the combined transmitted power for all layers in each layer set can be controlled independently among the layer sets. Therefore, the transmitted power of each layer set is therefore equal to the power in each antenna port signal set, and so embodiments herein refer to the power of a layer set and its corresponding antenna port signal set interchangeably. In some embodiments, it is sufficient to scale each set of the antenna port signals with a single value, that is, {C₁ . . . C)}=C′₁ and {C_{J+1}, . . . , C_{J+K}}=C′₂. Using only one scale factor value per set may be sufficient in cases where the average power of the antenna ports received by the network for an SRS resource (and therefore the corresponding antenna signal set) is similar, but the average power is different between the SRS resources and sets of antenna port signals.

This can occur for example when the antennas corresponding to an SRS resource have similar antenna patterns within an SRS resource, but different patterns between SRS resources, i.e. when wireless device 22 panels (e.g., antenna panels) are used.

The SRS signals are identified with SRS ports and may be comprised within an SRS resource. Therefore, a first and a second SRS resource could be transmitted on antenna set 1 and 2 in FIG. 13. It is possible that a single SRS resource with all J+K SRS signals could be used. However, NR precoders are designed to apply to an entire SRS resource, which is due in part to the requirement for UEs to transmit SRS ports simultaneously when precoding, and so only one precoder could be used if that design principle is maintained. Moreover, SRS resources are in general designed so that UEs can use different antenna patterns between resources, and so a multi-SRS resource design can better support wireless devices 22 with such antenna systems. Therefore, in the illustrated embodiment, a first set of SRS signals {SRS₁, . . . , SRS_{J}} is within a first SRS resource, while a second set of SRS signals {SRS_{J+1}, . . . , SRS_{J+K}} is within a second SRS resource.

These two SRS resources could be used for transmission of a single PUSCH, and would contain J and K ports, respectively. The first and second precoders, W₁ and W₂, could be used for transmission according to the first and second SRS resource. Up to J and K layers could be transmitted according to the first and second SRS resources, corresponding to a first and a second layer set, respectively. Codebook supporting J+K ports that combine ports in the two SRS resources or combines ports in a single SRS resource comprising J+K SRS ports may be used. In such cases, the power scaling for the PUSCH transmission could use a Rel-15 based design described above where the PUSCH power is scaled according to the number of non-zero power antenna ports used to transmit the PUSCH divided by the maximum number of SRS ports supported by the wireless device 22. However, for the design where a J port codebook is used for the first SRS resource and a K port codebook is used for the second SRS resource, there are two portions of antenna ports used for PUSCH transmission, and how power can be allocated within a layer set corresponding to each SRS resource and across the layer sets needs to be determined.

Therefore, in some embodiments, for each SRS resource, the power in each set of antenna signals for an SRS resource is scaled according to the number of antenna ports with non-zero power in the antenna port signal set used for that SRS resource. Then all antenna port signal sets are scaled by a factor of the inverse of the maximum number of layers that can be simultaneously transmitted in the wireless device 22 during multi-SRS resource transmission. Lastly, the power is split equally among the antenna port signals with non-zero power. A maximum number of simultaneously transmitted layers is used here because a maximum number of SRS ports supported by the wireless device 22 may not increase with multiple SRS resource transmission, and therefore an increased number of SRS ports beyond the 4 ports supported in Rel-17 NR may not be designed to support multi-SRS resource transmission. In this embodiment, the scaling does not exceed a value of 1, which ensures the maximum power of the wireless device 22 does not exceed the allocated power, while not requiring the design of a codebook or SRS resource that supports (J+K)>4 ports. It is also possible that the maximum number of transmission layers is less than the maximum supported number of antenna ports used for PUSCH transmission for a wireless device 22. Hence, in one embodiment, the PUSCH power is divided by the maximum number of simultaneous antenna ports supported by the wireless device 22 for PUSCH transmission.

The DMRS ports may be transmitted at the same power as the PUSCH layers or at a predetermined power offset from the PUSCH layers, in order for the network node 16 to estimate the SINR of the PUSCH layers from measurements of the DMRS. Therefore, in these embodiments, each layer of each layer set is mapped to a corresponding DMRS port, such as by multiplexing the DMRS signal together with the layer as shown in FIG. 13, where the mapping sets the power of the DMRS to have the same power as the PUSCH layer or to be at a predetermined power offset from the DMRS.

In some embodiments, a single DMRS port is mapped to a layer from two (or more) different layer sets. In this case, the total DMRS port power is equal to the output power used for the corresponding layer from the first layer set plus the output power used for the corresponding layer from the second layer set (with potential extra DMRS power offset boost per layer set).

Finally, the antenna port signal sets of the PUSCH are transmitted on corresponding antennas.

One or more of the embodiments above can be described in a general embodiment as transmitting a PUSCH according to two or more SRS resources where a precoder can be used for each resource, and where each layer set corresponding to a resource has a transmitted power determined according to the number of non-zero power antenna ports, and the layer sets each have a corresponding portion of total transmitted power.

In particular, a method of transmitting a physical channel in a wireless device 22 is disclosed, where the wireless device 22 receives signaling configuring the wireless device 22 with multiple SRS resources, wherein each SRS resource contains less than N ports and N is a value indicated by the wireless device 22 that identifies one of a maximum number of layers and a maximum number of SRS ports that the wireless device 22 can transmit. The wireless device 22 also receives an indication of a first and second SRS resource of the SRS resources, wherein the first and second SRS resource contains J and K SRS ports, respectively, and J+K<=N. The wireless device 22 distributes modulation symbols carrying a set of coded information bits among a first and second set of layers. The wireless device 22 further multiplexes a demodulation reference signal (DMRS) identified by a DMRS port of the physical channel together with each layer of the first and second set of layers, where each DMRS port is specific to its corresponding layer. When J>1, the wireless device 22 receives an indication of a first precoder to be used on antenna ports that carry the physical channel, where the first precoder corresponds to the first SRS resource, and precodes the first set of layers of the physical channel to form a first antenna port signal set.

When K>1, the wireless device 22 receives an indication of a second precoder to be used on antenna ports that carry the physical channel, where the second precoder corresponds to the second SRS resource, and precodes the second set of layers of the physical channel to form a second antenna port signal set. The wireless device 22 multiplies the power of each antenna port signal in the first antenna port signal set by the number of antenna ports with non-zero power in the first antenna port signal set, thereby forming a first portion of transmit power, and multiplies the power of each antenna port signal in the second antenna port signal set by the number of antenna ports with non-zero power in the second antenna port signal set, thereby forming a second portion of transmit power. The wireless device 22 further sets a transmit power for the first and second antenna port signal sets according to the first and second portion of transmit power, respectively. Lastly, the wireless device 22 transmits the antenna port signal sets on corresponding antennas.

In some embodiments, a wireless device 22 may support multi-SRS transmission where the number of simultaneously used SRS ports Ntotal is more than the maximum number of layers the wireless device 22 supports. Such a wireless device 22 could have reduced complexity baseband processing by having a lower maximum PUSCH data rate. In order to minimize the wireless device 22 power amplifier complexity, an equal maximum power for each amplifier may be supported/provided/configured, where the combined total power of all amplifiers is a maximum power to be transmitted by the wireless device 22. It is also possible to define an SRS resource with an increased number of SRS ports and corresponding codebooks for UL MIMO transmission. In such a case, a wireless device 22 could support both an SRS resource with an increased number of ports and multiple SRS resource based transmission with J>1 and K>1 SRS ports.

Therefore, in a similar embodiment, for each SRS resource, the power in each set of antenna port signals for the resource is again multiplied by the number of antenna ports with non-zero power in the antenna port signal set. However, all layers for all resources are scaled by a factor of the inverse of the maximum number of SRS ports that can be simultaneously used for transmission of the physical channel in the UE during multi-SRS resource transmission.

It can be beneficial for a wireless device 22 with multiple transmit chains to virtualize those transmit chains such that they appear to be a single antenna when received by the network node 16. By transmitting the same information on multiple virtualized antennas, the power of the antennas combines, and the transmission is received at higher SNR. This can allow lower power amplifiers to be used in the wireless device 22, or to save power in the wireless device 22. This use of virtualization reduces the number of SRS ports available for SRS resources and may result in single port SRS resources. This motivates the consideration of embodiments with J<Ntotal or K<Ntotal, where Ntotal is the total number of Tx chains in the wireless device 22, and may also motivate cases with J=1 or K=1.

When a single port SRS resource is used in a multi-SRS resource transmission, a UL MIMO codebook may not be needed, since there are not ports to combine with a codebook. As such, a default precoder with a single element with value 1 could be used in place of the precoder, or the single SRS port could be set equal to the DMRS port, etc. Moreover, some embodiments using a codebook to produce layers corresponding to an SRS resource only receive an indication of a precoder for that SRS resource when the number of SRS ports in the resource is greater than 1.

When virtualizing an antenna port to increase the power of a layer, it may be undesirable to reduce its transmitted power when applying MIMO power scaling. One approach to mitigate this is to multiply the power of an antenna port signal set by the number of antenna ports with non-zero power in the antenna port signal set divided by the number of ports in the SRS resource corresponding to the layer. This is similar to Rel-16 uplink full power UL MIMO Mode 2, and can be one method to extend Rel-17 Mode 2 to support multi-SRS resource transmission. In an example embodiment, a wireless device 22 has 8 Tx chains, and therefore a maximum of 8 layers, a first SRS resource of J=4 ports could use a non-zero antenna port precoder for each of 4 layers and a second SRS resource of K=1 ports could use a default precoder with one non-zero antenna port for one layer. One embodiment could use a scaling factor for the 4 layers of the first SRS resource equal to 4/8 and also 1/8 for the layer for the second SRS resource. Since the second SRS resource's port is virtualized to reach 4 times higher power, or 4/8 off the total power available in the array (assuming equal power is supported for all 8 Tx chains), then the 1/8 scaling is reduces the power by a factor of 4. If instead the scaling is based on sum of the number of SRS ports in the used SRS resources, then the 4 layers for the first SRS resource will have a 4/(4+1)=4/5 scale factor, while the layer for second SRS resource would also be 1/5. This may have the problem that the power for the first SRS resource on all layers is 4/5 of the total, although the number of Tx chains is only 1/2, and so the actual power that can be transmitted can't reach 4/5 of the total.

Another approach would be to limit the maximum power per SRS resource according to a wireless device 22's Tx chain's contribution to the total power. In one embodiment a wireless device 22 has a maximum number of layers it can transmit with multiple SRS resources. The power scaling factor is then the number of non zero power antenna ports in an antenna port signal set/(Ni*M), where Ni is the number of ports in SRS resource i used for transmission. In the example configuration, the first SRS resource would have 4/(4*2)=4/8 scaling for the corresponding 4 antenna port signals and 1/(1*2)=1/2 scaling for its corresponding antenna port signal. The total transmitted power scaling is therefore 1/2+1/2=1, and so the full power of the wireless device 22 is used, and it is also split equally among the SRS resources (carried by the different panels). In another embodiment, a wireless device 22 may have different numbers of Tx chains in different panels (e.g., antenna panels). In such an embodiment, it can be beneficial for the power scaling account for the variation among panels. The power scaling therefore is (the number of non zero power ports used to transmit an antenna port signal set)/(Ni*Ntotal/Nmax,i), where Ni is the number of ports in SRS resource i used for transmission, Nmax,i is a maximum number of ports that can be supported in a group of SRS resources containing the SRS resource i, and Ntotal is the sum of Nmax,i for the used SRS resources. In an example embodiment with 4 and 2 Tx chains in two panels, respectively, SRS resources with J=4 and K=2 are selected. A rank 2 transmission is used for the first SRS resource, with 4 non-zero power antennas used for each layer, and so the scale factor for the first resource is (4+4)/(4*6/4)=8/6. The power is split equally among the non-zero power antenna ports corresponding to the SRS resource, the power is further scaled by 1/4, leading to a total power scaling factor of (8/6)/4=2/3 for layers in the first SRS resource. A rank 2 transmission with 2 non-zero power ports per layer is used for the second SRS resource, which results in a scale factor of (2+2)/(2*6/2)=4/6. The equal power split among non-zero power antenna ports is then a factor of 1/2, leading to a total power scaling factor of (4/6)/2=1/3 for layers in the second SRS resource. The total transmitted power scaling is therefore 2/3+1/3=1, and so the full power of the array is used, and it is also split equally among the SRS resources (carried by the different panels).

A first modification to the general embodiment described above can be described as scaling power down by either a number of SRS ports in each SRS resource to allow dynamic virtualization, or if dynamic virtualization is not used, by a total number of layers or ports supported by the wireless device 22 in multi-SRS transmission, and then splitting power equally across non-zero power antenna ports. In the general embodiments step of setting a transmit power, the wireless device 22 further divides the first portion of transmit power by an integer value P1, and splits the divided power equally across antenna port signals with non-zero power, wherein P1 is equal to one of J; a maximum number of SRS ports that the wireless device 22 can use when transmitting according to multiple SRS resources; and a maximum number of layers that the wireless device 22 can transmit when transmitting according to multiple SRS resources. The wireless device 22 also divides the second portion of transmit power by an integer value P2, and splits the divided power equally across antenna port signals with non-zero power, wherein P2 is equal to one of K; a maximum number of SRS ports that the wireless device 22 can use when transmitting according to multiple SRS resources; and a maximum number of layers that the wireless device 22 can transmit when transmitting according to multiple SRS resources.

Second modification to the general embodiment described above includes splitting power among non-zero power antenna ports for each SRS resource, rather than splitting it equally among all transmitted ports. More specifically, in addition or alternative to the second modification to the general embodiment, the wireless device 22 further divides the first portion of transmit power by P1, and splits the divided power equally across antenna port signals of the first antenna port signal set with non-zero power. The wireless device 22 also divides the second portion of transmit power by P2, and splits the divided power equally across antenna port signals of the second antenna port signal set with non-zero power.

As discussed above, having different received power levels can make it beneficial to transmit with a distinct power per panel for the purpose of link adaptation. One way to set power differently between panels can be to use different power control parameters for the panels. Power control parameters can include those defined in 3GPP standards such as in, for example, section 7.1.1 of 3GPP TS 38.213 rev. 16.0.0. So called ‘open loop’ power control parameters such as α_{b,f,c}(j) and P_{0_PUSCH,f,c} could be used to allow the power per antenna port signal set, or equivalently per layer set, to be set to a fixed level and/or to be determined based on estimates of pathloss from downlink measurements.

Furthermore, closed loop power control of each panel could be enabled by setting the power of an antenna port signal set, or equivalently a layer set, according to the PUSCH power control adjustment state f_{b,f,c}(i, l), where the index of an antenna port signal set or a layer set is associated with power control adjustment state index l. Applying either or both of open and closed loop power control differently for the different antenna port signal sets or layer sets allows the difference in power between the sets (the ‘dynamic range’) to be tens of dBs, providing a very flexible power control mechanism.

The use of different power control parameters or power control loops is also supported for SRI based power control in 3GPP NR Rel-15, however this is a different mechanism, since the different parameters or sets are used at different instants in time, which does not require that the power is shared among the power control loops.

An alternative way to set power differently between panels can be to define power offsets between the layer sets, or equivalently between the antenna port signal sets. Using relative power offsets between such sets can set power without requiring the large dynamic range found in embodiments using different power control parameters per set. Generally a small number of relative power offsets can provide good performance, enabling power offset signaling to have a bit or two for where two layer sets are used. For example, the power of a first antenna port signal set or layer set could be held constant (or equivalently scaled by a factor of 1), and a power scale factor from the set of {\sqrt{2}, 1/\sqrt{2}} could be indicated with one bit for a second antenna port signal set or layer set, allowing the second layer set to be 3 dB higher or lower than the first antenna port signal or layer set. Another example could be with a power offset values could be taken from {1, \sqrt{2}, 1/\sqrt{2}, 2}, where the second set can be at 0, −3, +3, or 6 dB higher than the first set. Similar embodiments can use other power offset values, possibly with different numbers of values, including numbers of values that are not powers of two (unlike the two and four values in the example sets described herein).

Therefore in some embodiments of the general embodiment, power can be split unequally across layer sets either by a controlled ratio or by power control parameters. More specifically in the embodiments, the wireless device 22 further receives an indication of a first and a second power level to transmit the first and second antenna port signal sets, wherein the indication comprises one of a) a first and a second set of power control parameters corresponding to the first and second SRS resource, respectively, and b) a relative power ratio between the first and second antenna port signal sets. The wireless device 22 adjusts the first and second portions of transmit power according to the first and second power level.

When each precoder is applied only to Tx chains within each panel and each panel transmits layers carrying different coded bits from the other panels, it may not be necessary to define a relative phase across the panels, since the different information content of the layers precludes that they could combine coherently. In such embodiments, each layer may map only once to one DMRS port such that there is a one-to-one mapping of layers to DMRS ports across the layer sets. One way to do this is to sequentially map the first set of layers according to the order of the DMRS ports {\tilde{p}₀, . . . , \tilde{p}ᵥ₋₁} produced by the precoders in each layer set, continue for the second layer immediately after the first, and so on. For example, if 2 and 3 layers are in the first and second set respectively, the layers could map to the DMRS ports with {\tilde{p}₀=\tilde{p}₀⁰, \tilde{p}₁=\tilde{p}₁⁰, \tilde{p}₂=\tilde{p}₀¹, \tilde{p}₃=\tilde{p}₁¹, \tilde{p}₄=\tilde{p}₂¹}, where {\tilde{p}₀⁰, \tilde{p}₁⁰} are the two DMRS ports corresponding to the layers in the first layer set and {\tilde{p}₀¹, \tilde{p}₁¹, \tilde{p}₂¹} are the three DMRS ports corresponding to the layers in the second layer set. More generally, in FIG. 13, layers corresponding to the SRS resource are {\tilde{p}₀=\tilde{p}₀⁰, \tilde{p}₁=\tilde{p}₁⁰, . . . , \tilde{p}_{L-1}=, \tilde{p}_{L-1}⁰} while those corresponding to the SRS resource are {\tilde{p}_{L}=\tilde{p}₀¹, \tilde{p}_{L+1}=\tilde{p}₁¹, . . . , \tilde{p}_{L+M-1}=\tilde{p}_{M-1}¹}.

Therefore in some embodiments of the general embodiment, in the step of mapping each layer of the first and second set of layers to a DMRS port of the physical channel, the wireless device 22 further maps each layer in the first and second set of layers to a unique DMRS port of the physical channel, such that each DMRS port corresponds to a single layer of the layers in the first and second set of layers.

In some such embodiments where DMRS ports are mapped consecutively across SRS resources, a layer of the first set of layers with index m is multiplexed with a DMRS port with index m, and a layer of the second set of layers with index m is multiplexed with a DMRS port with index m+L, where L is the number of layers in the first set of layers.

When the wireless device 22 transmits a layer on no more than one panel, the power of other panels naturally may not contribute to the power of the layer, and this motivates, at least in part, consideration of implementations where a wireless device 22 can transmit a same layer on multiple panels. If the transmissions from the panels are to combine coherently, the relative phase may need to be controlled, and this may require extensions of the Rel-17 NR UL MIMO codebooks. Such a design may be less desirable for a multi-SRS resource based design, since precoding and therefore control of relative phase of Tx chains may be performed by applying precoders within a single SRS resource. Furthermore, multi-panel implementations may be less likely to support control of relative phase among all Tx chains than single panel implementations. Mechanisms supporting non-coherent combination of a layer may therefore be of particular interest in multi-SRS resource based designs.

If two layers, each from different panels, are transmitted using a same DMRS port, the power from the panels may combine. If there is some control over the relative phase, such as a precoder that combines the layers to the DMRS port, is not specified, then the relative phase could be assumed to be set by wireless device 22 implementation. Furthermore, it could be specified that the wireless device 22 is not expected to maintain relative phase of a layer associated with multiple SRS resources.

UL MIMO antenna systems tend to be designed such that layers transmitted with a same power have similar SINR distributions. That is, while some layers tend to be stronger than others, no one layer generally is stronger than all other layers for all orientations of a MIMO device and over all precoders used by the wireless device 22. Then given that there is no general ordering for the power of MIMO layers, it may not be needed to select multiple combinations of a same number of layers for a DMRS port.

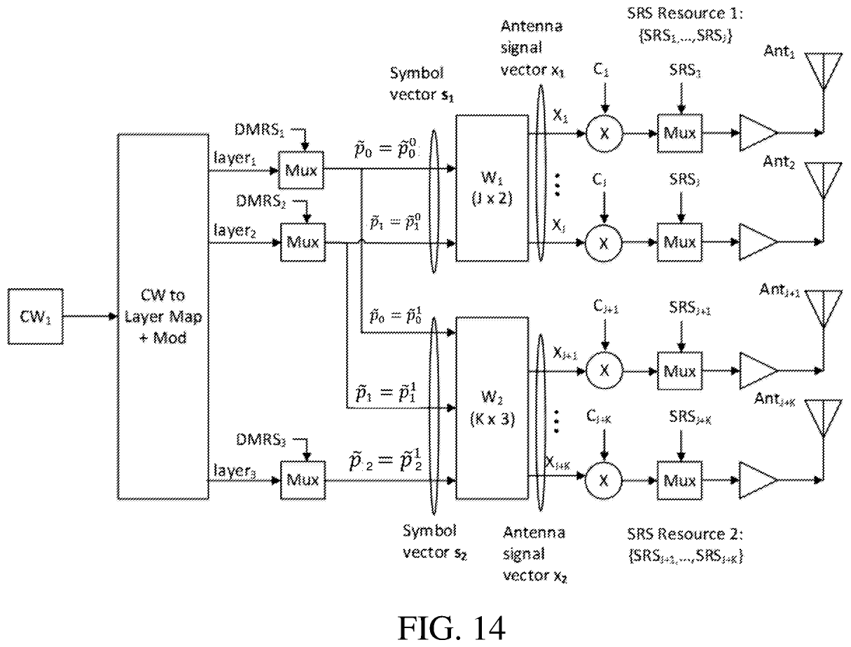

Therefore, one way to combine layers of different panels non-coherently can be to simply map each first layer of all the layer sets to a first DMRS port, and the second layer of all layer sets to a second DMRS port, and so on. For example, as shown in FIG. 14, if 2 layers are in the first layer set and are mapped to both the first and second SRS resources, and one layer is in the second layer set and is mapped to the second SRS resource, the layers could map to the DMRS ports with {\tilde{p}₀=\tilde{p}₀⁰, \tilde{p}₁=\tilde{p}₁⁰, \tilde{p}₀=\tilde{p}₀¹, \tilde{p}₁=\tilde{p}₁¹, \tilde{p}₂=\tilde{p}₂¹}, where {\tilde{p}₀, \tilde{p}₁, \tilde{p}₂} are the three unique DMRS ports associated with the three layers in the first and second layer sets. The notation {\tilde{p}₀⁰, \tilde{p}₁⁰} identifies that the first two layers are mapped to the first SRS resource and precoded by the first precoder. Similarly, the notation {\tilde{p}₀¹, \tilde{p}₁¹, \tilde{p}₂¹} identifies that all three layers are mapped to the second SRS resource and precoded by the second precoder.

In embodiments such as those shown in FIG. 14 all layers of a first layer set are mapped to two SRS resources, and layers in the second set of layers are mapped only to one SRS resource, for example, the second SRS resource. This may be represented by {\tilde{p}₀=\tilde{p}₀⁰, \tilde{p}₁=\tilde{p}₁⁰, . . . , \tilde{p}_{L-1}=\tilde{p}_{L-1}⁰, \tilde{p}₀=\tilde{p}₀¹, \tilde{p}₁=\tilde{p}₁¹, . . . , \tilde{p}_{L-1}=\tilde{p}_{L-1}¹, \tilde{p}_{L}=\tilde{p}_{L}¹, \tilde{p}_{L+1}=\tilde{p}_{L+1}¹, . . . , \tilde{p}_{L+1}=\tilde{p}_{L+M-1}¹}.

Therefore in some embodiments of the general embodiment, precoding at least the second set of layers includes precoding the second set of layers together with one or more layers in the first set of layers to form the second antenna port signal set.

As discussed above, multiple SRS schemes that control the relative phase of a layer transmitted with the two precoders may be designed as described herein. In cases where the extra gain from coherent combining are desired and where wireless device 22 implementations allow it, then such mechanisms can be supported by setting the relative phase of elements in the precoders that carry the same layer. Since the same layer is present in antennas corresponding to different SRS resources (e.g., those in different panels), the signal may combine constructively in the channel if the correct relative phases of the elements in the precoders are selected. This extra information can be included in the indications of the first and second precoders.

Therefore in embodiments where the first and second layer sets are precoded together, the wireless device 22 also adjusts at least one of a relative phase and a relative gain between an element of the first precoder and an element of the second precoder, where the element of the first precoder and the element of the second precoder correspond to a layer of the first set of layers.

As discussed above, it may be desirable to transmit only on one Tx chain in a panel. In such cases, there may be no need for a precoder to be indicated to the wireless device 22, since the wireless device 22 may transmit a layer directly on an antenna port without modifying the phase of the layer carried on the antenna port relative to its other antenna ports.

Therefore in some embodiments of the general embodiment, when J=1, the wireless device 22 precodes one layer of the first set of layers according to a scalar precoder with a value of 1, to form the first antenna port signal set. And when K=1, the wireless device 22 precodes one layer of the second set of layers according to a scalar precoder with a value of 1, forming second antenna port signal set.

Depending on channel conditions, it is possible that the antenna ports of an SRS resource are received by the network node 16 at much lower SNR than those of other SRS resources, such as when one panel is blocked by an object near the panel. In such cases, it can be beneficial for the wireless device 22 to transmit only the layer sets of the SRS resources that are received at good SNR levels. Therefore in some embodiments, only one SRS resource is indicated and only the layers associated with that SRS resource are transmitted.

In some embodiments of the general embodiment, the wireless device 22 receives an indication of a single SRS resource of the SRS resources, wherein the single SRS resource contains J SRS ports, respectively, and J<=N. The wireless device 22 distributes modulation symbols carrying a set of coded information bits among a single second set of layers. The wireless device 22 further multiplexes a demodulation reference signal (DMRS) identified by a DMRS port of the physical channel together with each layer of single set of layers, where each DMRS port is specific to its corresponding layer. When J>1, the wireless device 22 receives an indication of a first precoder to be used on antenna ports that carry the physical channel and that corresponds to the single SRS resource, and precodes the single set of layers to form a single antenna port signal set. The wireless device 22 multiplies the power of each antenna port signal in the single antenna port signal set by the number of antenna ports with non-zero power in the single antenna port signal set, thereby forming the first portion of transmit power. The wireless device 22 sets a transmit power for the single antenna port signal set according to the first portion of transmit power. Lastly, the wireless device 22 transmits the single antenna port signal set on corresponding antennas.

The SRS resources could be configured within one SRS resource set or multiple SRS resource sets. A benefit of configuring them within one SRS resource set is that wireless devices 22 can be expected to use different antenna patterns to transmit different SRS resources, and therefore allowing some network control over the directions in which the wireless device 22 transmits. On the other hand, different SRS resource sets are triggered independently, and allow different power control settings. Therefore, it can be beneficial from a power control or triggering perspective to configure the SRS resources used for multi-SRS transmission in different SRS resource sets. Therefore, in one embodiment the wireless device 22 is configured with SRS resources to be used for multi-SRS transmission in different SRS resource sets.

In some embodiments of the general embodiment, the first and second SRS resources are configured in a first and a second SRS resource set, respectively.

CW to SRS resources/resource sets mapping: When the SRS resources encounter different channel conditions, or the power is divided unequally among the layer sets according to embodiments herein, the capacity of the layer sets for the different SRS resources can be different. In such cases, it can be beneficial to adapt the MCS of the information carried each of the layer sets independently. This can be accomplished by carrying codewords on the different layer sets and setting the MCS of the different codewords according to the SINR of the layer sets.

Because the SINR of the different layer sets is often different, while the average SINR of the layers within each of the layers is similar, it can be beneficial to map a codeword to only one layer set. If the codeword were mapped to layers with widely different SINRs, the MCS may not be as well adapted to all layers. Therefore, in some embodiments, a first and a second codeword are each mapped to the first and the second layer set.

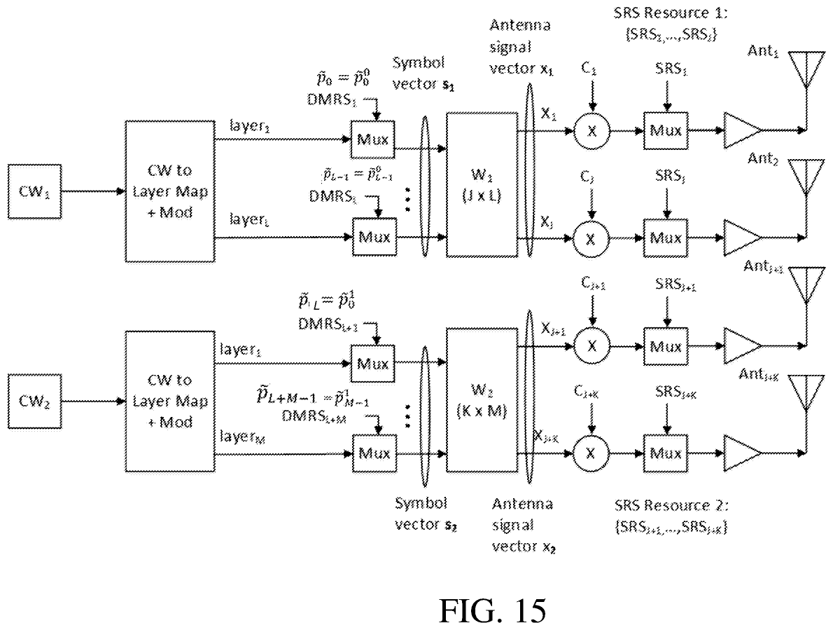

FIG. 15 is a diagram that illustrates examples of where multiple codewords may be used in multi-SRS resource transmission. A first codeword is mapped to layers 1 though L in the first layer set, while a second codeword is mapped to layers 1 through M in the second layer set. As in other embodiments, each layer is assigned a distinct DMRS, and so layers 1−L in the first codeword are multiplexed together with to DMRS 1−L, while layers 1−M in the second codeword are multiplexed together with to DMRS L+1 though L+M. The first and second layer sets are precoded with the first and second precoders, and then multiplied to adjust the power per layer set as in other embodiments. Further, some embodiments described herein give the ability to adjust power or to transmit with fewer layers in a layer set, thereby increasing the available power to a layer, which allows SNR to be adjusted per layer set, which can be effectively combined with the ability of this embodiment to adjust the MCS to match the SNR.

Therefore, in some embodiments, the wireless device 22 encodes a first and a second set of information bits according to a first and a second modulation and coding state (MCS), respectively, to produce a first and a second set of coded information bits. The wireless device 22 distributes modulation symbols carrying the set of coded information bits among the first and second set of layers, wherein it distributes the first set of coded information bits among the first set of layers and distributes the second set of coded information bits among the second set of layers.

### Some Embodiments

1. (Transmit PUSCH according to two or more SRS resources where a TPMI can be used for each SRS resource, and where each layer set corresponding to a SRS resource has a transmitted power determined according to the number of non-zero power antenna ports, and each layer set has a corresponding portion of total transmitted power.) A method of transmitting a physical channel in a wireless device 22, including one or more of:
a. Receiving signaling configuring the wireless device 22 with multiple SRS resources, wherein each SRS resource contains less than N ports and where N is a value indicated by the wireless device 22 that identifies one of a maximum number of layers and a maximum number of SRS ports that the wireless device 22 can transmit;
b. Receiving an indication of a first and second SRS resource of the SRS resources, wherein the first and second SRS resource contains J and K SRS ports, respectively, and J+K<=N;
c. Distributing modulation symbols carrying a set of coded information bits among a first and second set of layers;
d. Multiplexing a demodulation reference signal (DMRS) identified by a DMRS port of the physical channel together with each layer of the first and second set of layers, where each DMRS port is specific to its corresponding layer;
e. When J>1, receiving an indication of a first precoder to be used on antenna ports that carry the physical channel and that corresponds to the first SRS resource, precoding the first set of layers to form a first antenna port signal set;
f. When K>1, receiving an indication of a second precoder to be used on antenna ports that carry the physical channel and that corresponds to the second SRS resource, precoding at least the second set of layers using the second precoder to form a second antenna port signal set;
g. Multiplying the power of each antenna port signal in the first antenna port signal set by the number of antenna ports with non-zero power in the first antenna port signal set, thereby forming a first portion of transmit power;
h. Multiplying the power of each antenna port signal in the second antenna port signal set by the number of antenna ports with non-zero power in the second antenna port signal, thereby forming a second portion of transmit power;
i. Setting a transmit power for the first and second antenna port signal sets according to the first and second portion of transmit power, respectively;
j. Transmitting the antenna port signal sets on corresponding antennas.

2. (Power is either scaled down by a number of SRS ports in each SRS resource to allow dynamic virtualization or by a total number of layers or ports supported by the wireless device 22 in multi-SRS transmission when dynamic virtualization is not used, and then split equally across non-zero antenna ports.) The method of 1, wherein the step of setting a transmit power further includes one or more of:
a. dividing the first portion of transmit power by an integer value P1, and splitting the divided power equally across antenna port signals with non-zero power, wherein
   i. P1 is equal to one of
   ii. J,
   iii. a maximum number of SRS ports that the wireless device 22 can use when transmitting according to multiple SRS resources, and
   iv. a maximum number of layers that the wireless device 22 can transmit when transmitting according to multiple SRS resources; and
   v. a maximum number of simultaneous antenna ports supported for PUSCH transmission
b. dividing the second portion of transmit power by an integer value P2, and splitting the divided power equally across antenna port signals with non-zero power, wherein
   i. P2 is equal to one of
   ii. K,
   iii. a maximum number of SRS ports that the wireless device 22 can use when transmitting according to multiple SRS resources, and
   iv. and a maximum number of layers that the wireless device 22 can transmit when transmitting according to multiple SRS resources.
   v. a maximum number of simultaneous antenna ports supported for PUSCH transmission

3. (Power is split among non-zero antenna ports for each SRS resource, rather than splitting it equally among all transmitted ports.) The method of 2, further includes one or more of:
a. dividing the first portion of transmit power by P1, and splitting the divided power equally across antenna port signals of the first antenna port signal set with non-zero power; and
b. dividing the second portion of transmit power by P2, and splitting the divided power equally across antenna port signals of the second antenna port signal set with non-zero power.

4. (Transmitted power can be split unequally across layer sets either by a controlled ratio or by power control parameters) The method of any of 1-3, further including one or more of:
a. Receiving an indication of a first and a second power level to transmit the first and second antenna port signal sets, wherein the indication comprises one of
   i. A first and a second set of power control parameters corresponding to the first and second SRS resource, respectively, and
   ii. A relative power ratio between the first and second antenna port signal sets; and
b. Adjusting the first and second portions of transmit power according to the first and second power level.

5. (Transmit chains for different SRS resources transmit independently.) The method of any of 1-4, wherein the step of mapping each precoded layer of the first and second set of precoded layers to a DMRS port of the physical channel further includes one or more of:
a. Mapping each precoded layer in the first and second set of precoded layers to a unique DMRS port of the physical channel, such that each DMRS port corresponds to a single precoded layer of the precoded layers in the first and second set of precoded layers.

6. (Full power can be supported by transmitting a layer on both panels, possibly in a non-coherent manner.) The method of any of 1-4, wherein precoding at least the second set of layers using the second precoder to form a second antenna port signal set further includes one or more of:
a. precoding the second set of layers together with one or more layers in the first set of layers to form the second antenna port signal set

7. (Multi-SRS resource transmission can be co-phased between different antenna groups/panels) The method of 6, further includes:
a. Adjusting at least one of a relative phase and a relative gain between an element of the first precoder and an element of the second precoder, where the element of the first precoder and the element of the second precoder correspond to a layer of the first set of layers.

8. (Multi-SRS resource transmission can use an SRS resource with a single port) The method of any of 1-7, further includes one or more of:
a. When J=1, precoding one layer of the first set of layers according to a scalar precoder with a value of 1, to form the first antenna port signal set
b. When K=1, precoding one layer of the second set of layers according to a scalar precoder with a value of 1, forming second antenna port signal set

9. (Single SRS resource transmission case) The method of any of 1-8, further includes one or more of:
a. Receiving an indication of a single SRS resource of the SRS resources, wherein the single SRS resource contains J SRS ports, respectively, and J<=N;
b. Distributing modulation symbols carrying a set of coded information bits among a single second set of layers;
c. Multiplexing a demodulation reference signal (DMRS) identified by a DMRS port of the physical channel together with each layer of single set of layers, where each DMRS port is specific to its corresponding layer;
d. When J>1, receiving an indication of a first precoder to be used on antenna ports that carry the physical channel and that corresponds to the first SRS resource, and precoding the single set of layers to form a single antenna port signal set;
e. Multiplying the power of each antenna port signal in the single antenna port signal set by the number of antenna ports with non-zero power in the single antenna port signal set, thereby forming the first portion of transmit power; and
f. Setting a transmit power for the single antenna port signal set according to the first portion of transmit power;
g. Transmitting the single antenna port signal set on corresponding antennas.

10. (Layers are mapped consecutively across SRS resources) The method of any of 1-9, further includes one or more of:
a. A layer of the first set of layers with index m is multiplexed with a DMRS port with index m; and
b. A layer of the second set of layers with index m is multiplexed with a DMRS port with index m+L, where L is the number of layers in the first set of layers.

11. (The SRS resources can belong to different SRS resource sets to get power control per SRS resource) The method of any of 1-10, wherein
a. The first and second SRS resources are configured in a first and a second SRS resource set, respectively.

12. (The power is split equally between all the layers corresponding to one set of layers) The method of any of 1-11, further includes:
a. Dividing the transmit power equally between different layers within a set of layers

13. (The layer sets of the SRS resources are mapped to different CWs coded with different MCSs) The method of any 1-12, further includes:
a. Encoding a first and a second set of information bits according to a first and a second modulation and coding state (MCS), respectively, to produce a first and a second set of coded information bits; and
b. Distributing modulation symbols carrying the set of coded information bits among the first and second set of layers, further comprising distributing the first set of coded information bits among the first set of layers and distributing the second set of coded information bits among the second set of layers

Accordingly, one or more embodiments described herein provide for power to be allocated in a way suitable to wireless devices 22 with limited power capabilities on each Tx chain, for example where each Tx chain's power capability is Pmax/N, where Pmax is the rated power of the wireless device 22 and N is the number of Tx chains in the wireless device 22. Methods herein prevent that the power required would be exceeded for any given Tx chain. Methods are also provided that allow it to be controlled between sets of Tx chains (‘panels’) in the wireless device 22, in order to better control the SNR received from the panels by one or more network nodes 16. Power may also be shared among panels by mapping layers to more than one panel. Antennas in a panel can be virtualized to provide more power per antenna port. Multiple codewords can be carried on the different panels to better match the received SNR of those panels.

### Some Examples

Example A1. A network node 16 configured to communicate with a wireless device 22, the network node 16 configured to, and/or comprising a radio interface 62 and/or comprising processing circuitry 68 configured to:
cause transmission of a configuration for physical uplink shared channel, PUSCH, communications, the configuration configuring the use of at least a first reference signal, RS, resource and a second RS resource, the first RS resource being associated with a first precoder and a first layer set, the second RS resource being associated with a second precoder and a second layer set, the first and second layer sets being configured based on a number of non-zero-power antenna ports; and
receive PUSCH communications based at least on the configuration.

Example A2. The network node 16 of Example A1, wherein the first and second RS resources each includes less than N ports where N corresponds to one of a maximum number of layers and a maximum number of RS ports that the wireless device is configurable to transmit with.

Example A3. The network node 16 of Example A1, wherein each of the first layer set and second layer set corresponding to a portion of total transmitted power.

Example A4. The network node 16 of Example A1, wherein a transmission power associated with the received PUSCH is based on:
scaling down the transmission power by a number of RS ports in each of the first RS resource and second RS resource to allow for dynamically virtualization; and
splitting the scaled down transmission power equally across at least non-zero antenna ports.

Example A5. The network node 16 of Example A1, wherein a transmission power associated with the received PUSCH is based on:
scaling down the transmission power by a total number of one of layers and ports supported by the wireless device when dynamic virtualization is not used; and
splitting the scaled down transmission power equally across at least non-zero ports.

Example A6. The network node 16 of any one of Examples A4-A5, wherein the splitting is based on one of:
a split across non-zero ports for each of the first and second RS resources; and
a split equally among all transmitted ports.

Example B1. A method implemented in a network node 16 that is configured to communicate with a wireless device 22, the method comprising:
causing transmission of a configuration for physical uplink shared channel, PUSCH, communications, the configuration configuring the use of at least a first reference signal, RS, resource and a second RS resource, the first RS resource being associated with a first precoder and a first layer set, the second RS resource being associated with a second precoder and a second layer set, the first and second layer sets being configured based on a number of non-zero-power antenna ports; and
receiving PUSCH communications based at least on the configuration.

Example B2. The method of Example B1, wherein the first and second RS resources each includes less than N ports where N corresponds to one of a maximum number of layers and a maximum number of RS ports that the wireless device 22 is configurable to transmit with.

Example B3. The method of Example B1, wherein each of the first layer set and second layer set corresponding to a portion of total transmitted power.

Example B4. The method of Example B1, wherein a transmission power associated with the received PUSCH is based on:
scaling down the transmission power by a number of RS ports in each of the first RS resource and second RS resource to allow for dynamically virtualization; and
splitting the scaled down transmission power equally across at least non-zero antenna ports.

Example B5. The method of Example B1, wherein a transmission power associated with the received PUSCH is based on:
scaling down the transmission power by a total number of one of layers and ports supported by the wireless device 22 when dynamic virtualization is not used; and
splitting the scaled down transmission power equally across at least non-zero ports.

Example B6. The method of any one of Examples B4-B5, wherein the splitting is based on one of:
a split across non-zero ports for each of the first and second RS resources; and
a split equally among all transmitted ports.

Example C₁. A wireless device 22 configured to communicate with a network node 16, the wireless device 22 configured to, and/or comprising a radio interface 82 and/or processing circuitry 84 configured to
receive a configuration for physical uplink shared channel, PUSCH, communications, the configuration configuring the use of at least a first reference signal, RS, resource and a second RS resource, the first RS resource being associated with a first precoder and a first layer set, the second RS resource being associated with a second precoder and a second layer set, the first and second layer sets being configured based on a number of non-zero-power antenna ports; and
cause PUSCH communications based at least on the configuration.

Example C2. The wireless device 22 of Example C1, wherein the first and second RS resources each includes less than N ports where N corresponds to one of a maximum number of layers and a maximum number of RS ports that the wireless device 22 is configurable to transmit with.

Example C3. The wireless device 22 of Example C1, wherein each of the first layer set and second layer set corresponding to a portion of total transmitted power.

Example C4. The wireless device 22 of Example C1, wherein a transmission power associated with the transmitted PUSCH is based on:
scaling down the transmission power by a number of RS ports in each of the first RS resource and second RS resource to allow for dynamically virtualization; and
splitting the scaled down transmission power equally across at least non-zero antenna ports.

Example C5. The wireless device 22 of Example C1, wherein a transmission power associated with the transmitted PUSCH is based on:
scaling down the transmission power by a total number of one of layers and ports supported by the wireless device 22 when dynamic virtualization is not used; and
splitting the scaled down transmission power equally across at least non-zero ports.

Example C6. The wireless device 22 of any one of Examples C4-C5, wherein the splitting is based on one of:
a split across non-zero ports for each of the first and second RS resources; and
a split equally among all transmitted ports.

Example D1. A method implemented in a wireless device 22 that is configured to communicate with a network node 16, the method comprising:
receiving a configuration for physical uplink shared channel, PUSCH, communications, the configuration configuring the use of at least a first reference signal, RS, resource and a second RS resource, the first RS resource being associated with a first precoder and a first layer set, the second RS resource being associated with a second precoder and a second layer set, the first and second layer sets being configured based on a number of non-zero-power antenna ports; and
causing PUSCH communications based at least on the configuration.

Example D2. The method of Example D1, wherein the first and second RS resources each includes less than N ports where N corresponds to one of a maximum number of layers and a maximum number of RS ports that the wireless device 22 is configurable to transmit with.

Example D3. The method of Example D1, wherein each of the first layer set and second layer set corresponding to a portion of total transmitted power.

Example D4. The method of Example D1, wherein a transmission power associated with the transmitted PUSCH is based on:
scaling down the transmission power by a number of RS ports in each of the first RS resource and second RS resource to allow for dynamically virtualization; and
splitting the scaled down transmission power equally across at least non-zero antenna ports.

Example D5. The method of Example D1, wherein a transmission power associated with the transmitted PUSCH is based on:
scaling down the transmission power by a total number of one of layers and ports supported by the wireless device 22 when dynamic virtualization is not used; and
splitting the scaled down transmission power equally across at least non-zero ports.

Example D6. The method of any one of Examples D4-D5, wherein the splitting is based on one of:
a split across non-zero ports for each of the first and second RS resources; and
a split equally among all transmitted ports.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| 3GPP | Third Generation Partnership Project |
| ASN | Abstract Syntax Notation |
| CDM | Code-Division Multiplexing |
| CB | Codebook |
| CE | Control Element |
| CP-OFDM | Cyclic-Prefix-OFDM |
| CSI | Channel State Information |
| DCI | Downlink Control Information |
| DFT | Discrete Fourier Transform |
| DFT-S-OFDM | DFT-Spread-OFDM |
| DL | Downlink |
| DM-RS | Demodulation Reference Signal |
| FD-OCC | Frequency-Domain OCC |
| FDD | Frequency-Division Multiplexing |
| FR1 | Frequency Range 1 |
| FR2 | Frequency Range 2 |
| IDFT | Inverse DFT |
| gNB | gNodeB |
| LTE | Long Term Evolution |
| MAC | Medium Access Control |
| MIMO | Multiple-Input Multiple-Output |
| MCS | Modulation and Coding Scheme |
| NCB | Non-Codebook |
| NR | New Radio |
| OCC | Orthogonal Cover Code |
| OFDM | Orthogonal Frequency-Division Multiplexing |
| PA | Power Amplifier |
| PAPR | Peak-to-Average Power Ratio |
| PC | Power Control |
| PDCCH | Physical Downlink Control Channel |
| PDSCH | Physical Downlink Shared Channel |
| PSD | Power Spectral Density |
| PT-RS | Phase Tracking Reference Signal |
| PUCCH | Physical Uplink Control Channel |
| PUSCH | Physical Uplink Shared Channel |
| QPSK | Quadrature Phase-Shift Keying |
| RB | Resource Block |
| RF | Radio Frequency |
| RRC | Radio Resource Control |
| RS | Reference Signal |
| RSRP | Reference Signal Received Power |
| SCS | Subcarrier Spacing |
| SNR | Signal-to-Noise Ratio |
| SRI | SRS Resource Indicator |
| SRS | Sounding Reference Signal |
| SSB | Synchronization Signal Block |
| TD-OCC | Time-Domain OCC |
| TDD | Time-Division Duplexing |
| TPMI | Transmit Precoding Matrix Index |
| UE | User Equipment |
| UL | Uplink |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. (canceled)

2. The method of claim 41, wherein a total configured signal power for the physical channel is based on dividing either equally or unequally across either:
the antenna port signals in the first antenna port signal set with non-zero power; or
among ports corresponding to each resource, the dividing being based on either a controlled ratio of the first and second power signals or power control parameters for independent control of the first and second power signals.

3. The method of claim 41, wherein the physical channel comprises:
a first set of transmission layers precoded with the first precoder to generate the first antenna port signal set corresponding to the first physical channel portion;
a second set of transmission layers precoded with the second precoder to generate the second antenna port signal set corresponding to the second physical channel portion;
the first signal power being based at least in part on a multiplication of a power of each antenna port signal in the first antenna port signal set by a number of antenna ports with non-zero power in the first antenna port signal set; and
the second signal power being based at least in part on a multiplication of a power of each antenna port signal of the second antenna port signal set by a number of antenna ports with non-zero power in the second antenna port signal set.

4. The method of claim 3, wherein the first and the second layer set of transmission layers are mapped to a first and second set of DMRS ports, wherein the first set of DMRS ports corresponds only to the first set of transmission layers, and the second set of DMRS ports corresponds only to the second set of transmission layers.

5. (canceled)

6. The method of claim 41, wherein the first and second signal powers are based on dividing the first and second signal powers by N.

7. The method of claim 41, wherein the first and second signal powers are based on dividing the first and second signals powers by a first and a second number of SRS ports, respectively, wherein the first and second number of SRS ports are the number of SRS ports in the first and second SRS resources, respectively;
the first signal powers being split equally among the antenna ports signals of the first antenna port signal set; and
the second signal powers being split equally among the antenna ports signals of the second antenna port signal set.

8. The method of claim 41, wherein the physical channel signaling corresponds to a physical uplink shared channel.

9. A wireless device in communication with a network node, the wireless device comprising:
processing circuitry configured to:
receive signaling for configuring the wireless device with a plurality of SRS resources;
receive a first indication of a first precoder for use with a first antenna port signal set that carries a first portion of a physical channel and is associated with a first SRS resource of the plurality of SRS resources;
receive a second indication of a second precoder for use with a second antenna port signal set that carries a second portion of the physical channel and is associated with a second SRS resource of the plurality of SRS resources;
adjust the first and second physical channel portion according to the first and second indications, respectively, forming a first and second signal power, each antenna port signal in the first antenna port signal set being adjusted by a number of antenna ports of the first antenna port signal set with non-zero power, each antenna port signal in the second antenna port signal set being adjusted by a number of antenna ports of the second antenna port signal set with non-zero power; and
cause transmission of the physical channel.

10. The method of claim 41, wherein a total configured signal power for the physical channel is divided either equally or unequally across either:
the antenna port signals in the first antenna port signal set with non-zero power; or
among ports corresponding to each resource, the division being based on either a controlled ratio of the first and second power signals or power control parameters for independent control of the first and second power signals.

11.-32. (canceled)

33. A method implemented by a wireless device that is in communication with a network node, the method comprising:
receiving signaling for configuring the wireless device with a plurality of SRS resources;
receiving a first indication of a first precoder for use with a first antenna port signal set that carries a first portion of a physical channel and is associated with a first SRS resource of the plurality of SRS resources;
receiving a second indication of a second precoder for use with a second antenna port signal set that carries a second portion of the physical channel and is associated with a second SRS resource of the plurality of SRS resources;
adjusting the first and second physical channel portion according to the first and second indications, respectively, forming a first and second signal power, each antenna port signal in the first antenna port signal set being adjusted by a number of antenna ports of the first antenna port signal set with non-zero power, each antenna port signal in the second antenna port signal set adjusted by a number of antenna ports of the second antenna port signal set with non-zero power; and
causing transmission of the physical channel.

34. The method of claim 33, wherein a total configured signal power for the physical channel is divided either equally or unequally across either:
the antenna port signals in the first antenna port signal set with non-zero power; or
among ports corresponding to each resource, the division being based on either a controlled ratio of the first and second power signals or power control parameters for independent control of the first and second power signals.

35. The method of claim 33, further comprising:
precoding a first set of transmission layers with the first precoder to generate the first antenna port signal set corresponding to the first physical channel portion;
precoding a second set of transmission layers with the second precoder to generate the second antenna port signal set corresponding to the second physical channel portion;
adjusting the first signal power at least in part by multiplying a power of each antenna port signal in the first antenna port signal set by a number of antenna ports with non-zero power in the first antenna port signal set; and
adjusting the second signal power at least in part by multiplying a power of each antenna port signal of the second antenna port signal set by a number of antenna ports with non-zero power in the second antenna port signal set.

36. The method of claim 35, further comprising mapping the first and the second layer set of transmission layers to a first and second set of DMRS ports, wherein the first set of DMRS ports corresponds only to the first set of transmission layers, and the second set of DMRS ports corresponds only to the second set of transmission layers.

37. The method of claim 33, wherein each of the first SRS resource and second SRS resource contains less than N ports where N is a value corresponding to one of a maximum number of transmission layers and maximum number of SRS ports that the wireless device can transmit.

38. The method of claim 35, further comprising additionally adjusting the first and second signal powers by dividing the first and second signal powers by N.

39. The method of claim 35, further comprising:
additionally adjusting the first and second signal powers by dividing the first and second signals powers by a first and a second number of SRS ports, respectively, wherein the first and second number of SRS ports are the number of SRS ports in the first and second SRS resources, respectively;
splitting the adjusted first signal powers equally among the antenna ports signals of the first antenna port signal set; and
splitting the adjusted second signal powers equally among the antenna ports signals of the second antenna port signal set.

40. The method of claim 33, wherein the physical channel signaling corresponds to a physical uplink shared channel.

41. A method implemented by a network node that is in communication with a wireless device, the method comprising:
configuring the wireless device with a plurality of SRS resources;
causing transmission of a first indication of a first precoder for use with a first antenna port signal set that carries a first portion of a physical channel and is associated with a first SRS resource of the plurality of SRS resources;
causing transmission of a second indication of a second precoder for use with a second antenna port signal set that carries a second portion of the physical channel and is associated with a second SRS resource of the plurality of SRS resources; and
receiving transmission of the physical channel, the first and second physical channel portion being based on the first and second indications, respectively, for forming a first and second signal power, each antenna port signal in the first antenna port signal set being based on a number of antenna ports of the first antenna port signal set with non-zero power, each antenna port signal in the second antenna port signal set being based on a number of antenna ports of the second antenna port signal set with non-zero power.

42. The method of claim 41, wherein each of the first SRS resource and second SRS resource contains less than N ports where N is a value corresponding to one of a maximum number of transmission layers and maximum number of SRS ports that the wireless device can transmit.

43. A network node in communication with a wireless device, the network node comprising:
processing circuitry configured to:
configure the wireless device with a plurality of SRS resources;
cause transmission of a first indication of a first precoder for use with a first antenna port signal set that carries a first portion of a physical channel and is associated with a first SRS resource of the plurality of SRS resources;
cause transmission of a second indication of a second precoder for use with a second antenna port signal set that carries a second portion of the physical channel and is associated with a second SRS resource of the plurality of SRS resources;
receive transmission of the physical channel, the first and second physical channel portion being based on the first and second indications, respectively, for forming a first and second signal power, each antenna port signal in the first antenna port signal set being based on a number of antenna ports of the first antenna port signal set with non-zero power, each antenna port signal in the second antenna port signal set being based on a number of antenna ports of the second antenna port signal set with non-zero power.

44. The network node of claim 43, wherein a total configured signal power for the physical channel is based on dividing either equally or unequally across either:
the antenna port signals in the first antenna port signal set with non-zero power; or
among ports corresponding to each resource, the dividing being based on either a controlled ratio of the first and second power signals or power control parameters for independent control of the first and second power signals.
